(19) United States
(12) Patent Application Publication
(10) Pub. No.: US 2017/0255588 A1
(43) Pub. Date: Sep. 7, 2017

(54) MULTIPROTOCOL I3C COMMON COMMAND CODES

(71) Applicant: QUALCOMM Incorporated, San Diego, CA (US)

(72) Inventor: Radu PITIGOI-ARON, San Jose, CA (US)

(21) Appl. No.: 15/442,164

(22) Filed: Feb. 24, 2017

Related U.S. Application Data
(60) Provisional application No. 62/304,803, filed on Mar. 7, 2016.

(51) Int. Cl. G06F 13/42; G06F 13/364

(52) U.S. Cl. CPC G06F 13/4282; G06F 13/364

(57) ABSTRACT

System, methods and apparatus offer improved performance for a communication interface that provides for the coexistence of devices on a serial bus. A bus master coupled to a serial bus configures a transceiver for communicating on the serial bus when the serial bus is operated in a high data rate mode of operation on the serial bus, and while the serial bus is operated in the high data rate mode of operation, transmits a first command addressed to an invalid slave device address, and transmits a second command addressed to a valid slave device address. The second command may be defined for transmission when the serial bus is operated in a low data rate mode of operation.

### BACKGROUND

This application claims the benefit of U.S. Provisional Application Ser. No. 62/304,803 filed in the U.S. Patent Office on Mar. 7, 2016, the entire content of this application being incorporated herein by reference and for all applicable purposes.

### TECHNICAL FIELD

The present disclosure relates generally to an interface between processors and peripheral devices and, more particularly, to improving performance of devices adapted to coexist on a serial bus with lower-performance devices.

### BACKGROUND

The Inter-Integrated Circuit serial bus, which may also be referred to as the I2C bus or the I²C bus, is a serial single-ended computer bus that was intended for use in connecting low-speed peripherals to a processor. The I2C bus is a multi-master bus in which each device can serve as a master and a slave for different messages transmitted on the I2C bus. The I2C bus can transmit data using only two bidirectional open-drain connectors, including a Serial Data Line (SDA) and a Serial Clock Line (SCL). The connectors typically include signal wires that are terminated by pull-up resistors. Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation.

In some systems and apparatus, mobile communications devices, such as cellular phones, may employ multiple devices, such as cameras, displays and various communications interfaces that consume significant bandwidth. A serial bus in such systems and apparatus may employ a combination of I2C protocols and other protocols (such as the I3C protocol, which is derived from the I2C protocol) that can increase available bandwidth on the serial bus through higher transmitter clock rates, for example. The I3C specifications define a communication interface that can support multiple modes of communication, including high-speed and low-speed modes that may differ from I2C modes of communication. Devices that can communicate using I3C modes of operation can coexist on a bus that includes I2C devices using various techniques, including the use of signaling that is not recognized or ignored by an I2C device. Devices that can communicate using different I3C modes of operation can coexist on the same bus. Certain coexistence issues may remain in these systems when signaling associated may appear to legacy devices to be illegal or unrecognizable under I2C protocols. For example, a master device may be forced to communicate bus control commands using the signaling defined for the slowest device coupled to a shared serial bus, with a corresponding reduction in throughput and/or increased latency.

Accordingly, there exists an ongoing need for providing improved coexistence between devices connected to a shared serial interface.

### SUMMARY

Embodiments disclosed herein provide systems, methods and apparatus that provide improved coexistence of devices coupled to a serial bus by eliminating the occurrence of void messages.

In an aspect of the disclosure, a method of data communications at a bus master device coupled to a serial bus includes configuring a transceiver for communicating on the serial bus when the serial bus is operated in a high data rate mode of operation on the serial bus, and while the serial bus is operated in the high data rate mode of operation, transmitting on the serial bus, a first command addressed to an invalid slave device address, and transmitting on the serial bus, a second command addressed to a valid slave device address. The second command may be defined for transmission when the serial bus is operated in a low data rate mode of operation.

The high data rate mode of operation may be compliant with an I3C high data rate mode of operation and the low data rate mode of operation is compliant with an I3C single data rate mode of operation. The second command may include a common command code defined for transmission while the serial bus is operated in the I3C single data rate mode of operation.

The method may include transmitting a start sequence or a restart command on the serial bus while the serial bus is operated in the low data rate mode of operation and prior to transmitting the first command, and transmitting a mode command while the serial bus is operated in the low data rate mode of operation and prior to transmitting the first command. The mode command may cause the serial bus to transition to the high rate mode of operation.

In one example, the high data rate mode of operation may correspond to an I3C high data rate-double data rate mode of operation. In other examples, the high data rate mode of operation corresponds to an I3C high data rate-ternary legacy symbols mode of operation or an I3C high data rate-ternary pure symbols mode of operation.

The first command may be transmitted by populating a first field of the first command with a value calculated to reduce consumption of energy by the transceiver during transmission, and populating a second field of the first command with the invalid slave device address. The first command may be transmitted by populating a first field of the first command with error detection or correction information, and populating a second field of the first command with the invalid slave device address.

The second command may be transmitted by populating a first field of the second command with a common command code defined for transmission while the serial bus is operated in the I3C SDR mode of operation, populating a second field of the second command with the valid slave device address when the common command code is a directed common command code, and populating the second field of the second command with a value calculated to reduce consumption of energy by the transceiver during transmission when the common command code is a broadcasted common command code.

The second command may be transmitted by populating a first field of the second command with a common command code defined for transmission while the serial bus is operated in the I3C SDR mode of operation, populating a second field of the second command with the valid slave device address when the common command code is a directed common command code, and populating the second field of the second command with error detection or correction information when the common command code is a broadcasted common command code.

In an aspect of the disclosure, a bus master configured to be coupled to a serial bus has a transceiver configured to exchange data through a data line of the serial bus, a line driver configured to control signaling state of a clock line of the serial bus, and a transmitter circuit coupled to the transceiver and the line driver. While the serial bus is operated in the high data rate mode of operation, the transmitter circuit may be configured to transmit on the serial bus, a first command addressed to an invalid slave device address, transmit on the serial bus, a second command addressed to a valid slave device address. The second command may be defined for transmission when the serial bus is operated in a low data rate mode of operation.

The second command may include a common command code defined for transmission while the serial bus is operated in an I3C single data rate mode of operation. The transmitter circuit may be configured to populate a first field of the second command with a common command code encoded for transmission when the serial bus is operated in the I3C single data rate mode of operation, populate a second field of the second command with the valid slave device address when the common command code is a directed common command code, and populate the second field of the second command with a value calculated to reduce consumption of energy by the transceiver during transmission when the common command code is a broadcasted common command code.

The high data rate mode of operation is compliant with an I3C high data rate mode of operation and the low data rate mode of operation is compliant with an I3C single data rate mode of operation, and the transmitter circuit may be configured to populate a first field of the second command with a common command code encoded for transmission while the serial bus is operated in the I3C SDR mode of operation populate a second field of the second command with the valid slave device address when the common command code is a directed common command code, and populate the second field of the second command with error detection or correction information when the common command code is a broadcasted common command code.

The transmitter circuit may be configured to transmit a start sequence on the serial bus while the serial bus is operated in the low data rate mode of operation and prior to transmitting the first command, and transmit a mode command while the serial bus is operated in the low data rate mode of operation and prior to transmitting the first command, where the mode command causes the serial bus to transition to the high rate mode of operation.

The transmitter circuit may be configured to transmit a restart command on the serial bus while the serial bus is operated in the high data rate mode of operation and prior to transmitting the first command.

In one example, the high data rate mode of operation corresponds to an I3C high data rate-double data rate mode of operation. In other examples, the high data rate mode of operation corresponds to an I3C high data rate-ternary legacy symbols mode of operation or an I3C high data rate-ternary pure symbols mode of operation.

The transmitter circuit may be configured to populate a first field of the first command with a value calculated to reduce consumption of energy by the transceiver during transmission, and populate a second field of the first command with the invalid slave device address.

The transmitter circuit may be configured to populate a first field of the first command with error detection or correction information, and populate a second field of the first command with the invalid slave device address.

In an aspect of the disclosure, a processor readable storage medium having code stored thereon that is executable by a processor. The code may include instructions that cause the processor to configure a transceiver for communicating on the serial bus when the serial bus is operated in a high data rate mode of operation on the serial bus and, while the serial bus is operated in the high data rate mode of operation, transmit a first command over the serial bus to an invalid slave device address, and transmit on the serial bus, a second command addressed to a valid slave device address. The second command may be defined for transmission when the serial bus is operated in a low data rate mode of operation.

The code for transmitting the second command may include code for populating a first field of the second command with a common command code defined for transmission while the serial bus is operated in a I3C single data rate mode of operation, and populating a second field of the second command with the valid slave device address when the common command code is a directed common command code.

### BRIEF DESCRIPTION OF THE DRAWINGS

FIG. 1 depicts an apparatus employing a data link between IC devices that selectively operates according to one of plurality of available standards.

FIG. 2 illustrates a system architecture for an apparatus employing a data link between IC devices.

FIG. 3 illustrates a configuration of slave devices coupled to a common serial bus where the slave devices communicate using different protocols.

FIG. 4 illustrates timing relationships between data and clock signals transmitted on a serial bus that uses multiple communications protocols.

FIG. 5 illustrates the operation of a spike filter employed in certain slave devices.

FIG. 6 illustrates signaling associated with start and stop conditions employed to delineate transmissions on an I2C bus.

FIG. 7 illustrates a timing diagram of an I2C one byte write data operation.

FIG. 8 illustrates signaling associated with repeated start conditions used on an I2C bus.

FIG. 9 illustrates signaling states on a serial bus when the serial is operated in accordance with an I3C mode of operation.

FIG. 10 illustrates the transmission of command codes on a serial data link configured to support a single data rate mode of operation

FIG. 11 illustrates the transmission of command codes on a serial data link configured to support a first high-data rate mode of operation.

FIG. 12 illustrates the transmission of command codes on a serial data link configured to support second and third first high-data rate modes of operation.

FIG. 13 illustrates a first example of a high data-rate transmission that includes low-data rate command codes in accordance with certain aspects disclosed herein.

FIG. 14 illustrates a second example of a high data-rate transmission that includes low-data rate command codes in accordance with certain aspects disclosed herein.

FIG. 15 is a block diagram illustrating an example of an apparatus employing a processing system that may be adapted according to certain aspects disclosed herein.

FIG. 16 is a flow chart of method of data communications at a bus master device coupled to a serial bus according to one or more aspects disclosed herein.

FIG. 17 is a diagram illustrating an example of a hardware implementation for a transmitting apparatus that communicates over a serial bus in accordance with one or more aspects disclosed herein.

### DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures, and techniques may not be shown in detail in order not to obscure the embodiments. Various aspects are now described with reference to the drawings. In the following description, for purposes of explanation, numerous specific details are set forth in order to provide a thorough understanding of one or more aspects. It may be evident, however, that such aspects may be practiced without these specific details.

Overview

According to certain aspects disclosed herein, devices coupled to an I3C bus may be adapted to issue and/or respond to commands adapted for transmission in a high-speed mode of operation of an I3C bus, where the commands are conventionally coded for, and transmitted in low-speed mode. A command that is coded for low-speed mode may be referred to as common command code (CCC). By transmitting CCCs in the high-speed mode, transitions between the high-speed and low-speed modes of operation can be avoided. A significant increase in overall data throughput on the I3C bus can be accomplished when transitions between the high-speed and low-speed modes of operation are avoided. In some examples, the overall duration of transaction time may be reduced by 13.5 μs per transaction, or more. Transaction time savings of 13.5 μs can be substantial when, for example, high-speed throughput are measured in the in the range of 20 Mbps to 33 Mbps. In examples where a low-speed mode of operation is used to support legacy I2C devices, the overall duration of the transaction time may be reduced by 275 μs or more, depending on the bus configuration and the complexity of the command Methods are disclosed herein that are compliant or compatible with existing I3C specifications. In various examples, circuits and logic in existing equipment can be adapted or configured to implement the disclosed techniques.

### Example of a Mobile Communication Employing a Serial Bus

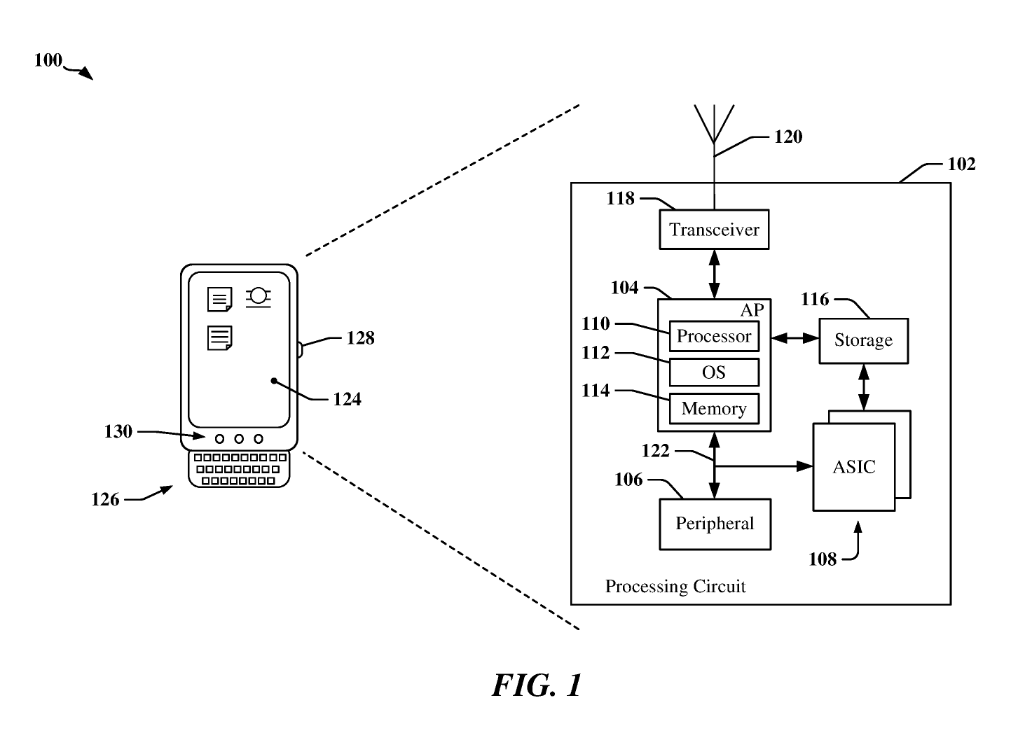

FIG. 1 depicts an apparatus 100 that may employ a communication link deployed within and/or between IC devices. In one example, the apparatus 100 may include a communication device that communicates through a radio frequency (RF) communications transceiver 118 with a radio access network (RAN), a core access network, the Internet and/or another network. The communications transceiver 118 may be embodied in, or operably coupled to a processing circuit 102. The processing circuit 102 may be implemented using an SoC and/or may one or more IC devices. In one example, the processing circuit 102 may include one or more application processors 104, one or more ASICs 108, and one or more peripheral devices 106 such as Codecs, amplifiers and other audiovisual components. Each ASIC 108 may include one or more processing devices, logic circuits, storage, registers, and so on. An application processor 104 may include a processor 110 and memory 114, and may be controlled by an operating system 112 that is loaded from internal or external storage 116 as data and instructions that are executable by the processor 110. The instructions that may be executed by a processor 110 of the processing circuit 102, through the services of one or more of an operating system and an application programming interface. In one example, the processor may load and/or execute software modules residing in storage media, such as the memory 114 and/or external storage 116. The memory 114 may include read-only memory (ROM) or random-access memory (RAM), electrically erasable programmable ROM (EEPROM), flash cards, or any memory device that can be used in processing systems and computing platforms.

The processing circuit 102 may include or access a local database implemented in the memory 114, for example, where the database can be used to maintain operational parameters and other information used to configure and operate the apparatus 100. The local database may be implemented as a set of registers, or may be implemented in a database module, flash memory, magnetic media, non-volatile or persistent storage, optical media, tape, soft or hard disk, or the like. The processing circuit may also be operably coupled to external devices such as an antenna 120, a display 124, operator controls, such as buttons 128, 130 and a keypad 126 among other components.

A data bus 122 may be provided to support communication between the application processor 104, ASICs 108 and/or the peripheral devices 106. The data bus 122 may be operated in accordance with one or more standards and/or protocols defined for interconnecting certain components of mobile devices. For example, there are multiple types of interface defined for communications between an application processor and display and camera components of a mobile device, or between a display controller deployed as a standalone peripheral 106 or provided in an ASIC 108. Some components employ an interface that conforms to standards specified by the Mobile Industry Processor Interface (MIPI) Alliance. For example, the MIPI Alliance defines the I3C interface standards that enable designers of mobile devices to achieve design goals including scalability, reduced power, lower pin count, ease of integration, and consistency between system designs.

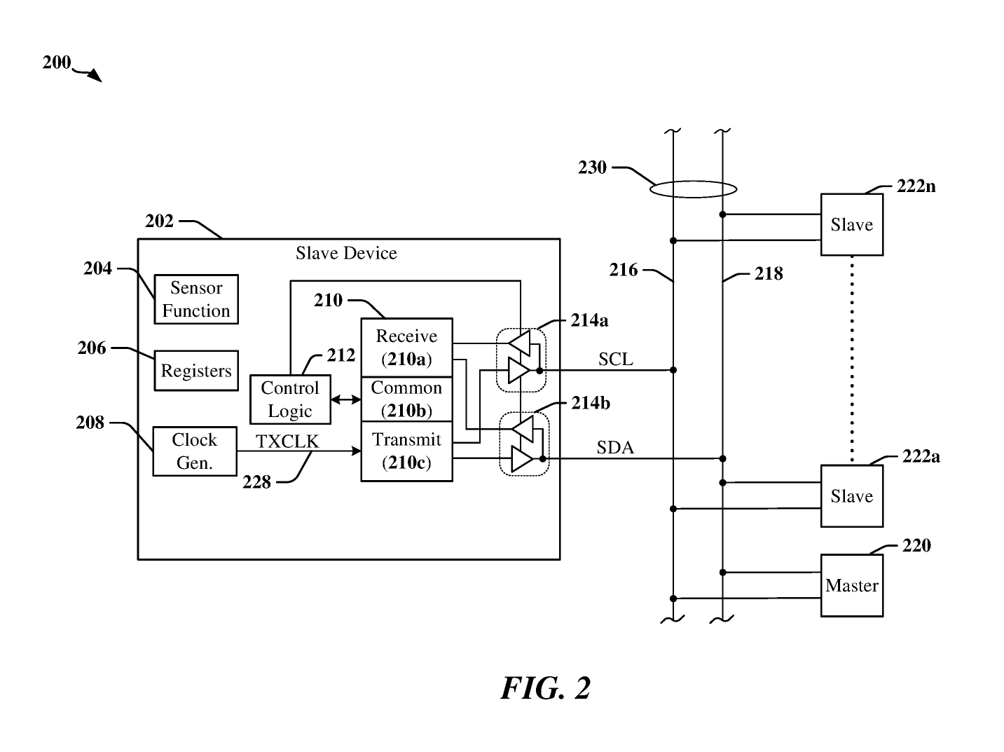

FIG. 2 is a block schematic drawing illustrating certain aspects of an apparatus 200 that includes multiple devices 202, 220 and 222a-222n connected to a communications bus 230. The devices 202, 220 and 222a-222n may include one or more semiconductor integrated circuit (IC) devices, such as an applications processor or an ASIC. The devices 202, 220 and 222a-222n may include a modem, a signal processing device, a display driver, a camera, a user interface, a sensor, a sensor controller, a media player, a radio frequency (RF) transceiver, and/or other such components or devices. The apparatus 200 may be embodied in a mobile communication device.

In one example, the apparatus 200 includes multiple devices 202, 220 and 222a-222n that communicate using an I2C bus 230 and at least one imaging device 202 may be configured to operate as a slave device on the I2C bus 230. The imaging device 202 may be adapted to provide a sensor control function 204. In one example, the sensor control function 204 may include circuits and modules that support an image sensor. In other examples, the sensor control function 204 may control and/or communicate with one or more sensors that measure environmental conditions. In addition, the imaging device 202 may include configuration registers or other storage 206, control logic 212, a transceiver 210 and line drivers/receivers 214a and 214b. The control logic 212 may include a processing circuit such as a state machine, sequencer, signal processor or general-purpose processor. The transceiver 210 may include a receiver 210a, a transmitter 210c and common circuits 210b, including timing, logic and storage circuits and/or devices. In one example, the transmitter 210c encodes and transmits data based on timing provided in a signal 228 provided by a clock generation circuit 208.

Two or more of the devices 202, 220 and/or 222a-222n may be adapted according to certain aspects and features disclosed herein to support a plurality of different communication protocols over a common bus, which may include the Inter-Integrated Circuit (I2C) protocol, and/or the I3C protocol. In some instances, devices that communicate using the I2C protocol can coexist on the same 2-wire interface with devices that communicate using I3C protocols. In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 230, in addition to data formats and aspects of bus control. In some aspects, the I2C and I3C protocols may define direct current (DC) characteristics affecting certain signal levels associated with the 2-wire bus 230, and/or alternating current (AC) characteristics affecting certain timing aspects of signals transmitted on the 2-wire bus 230.

### Coexistence of Devices Coupled to a Serial Bus

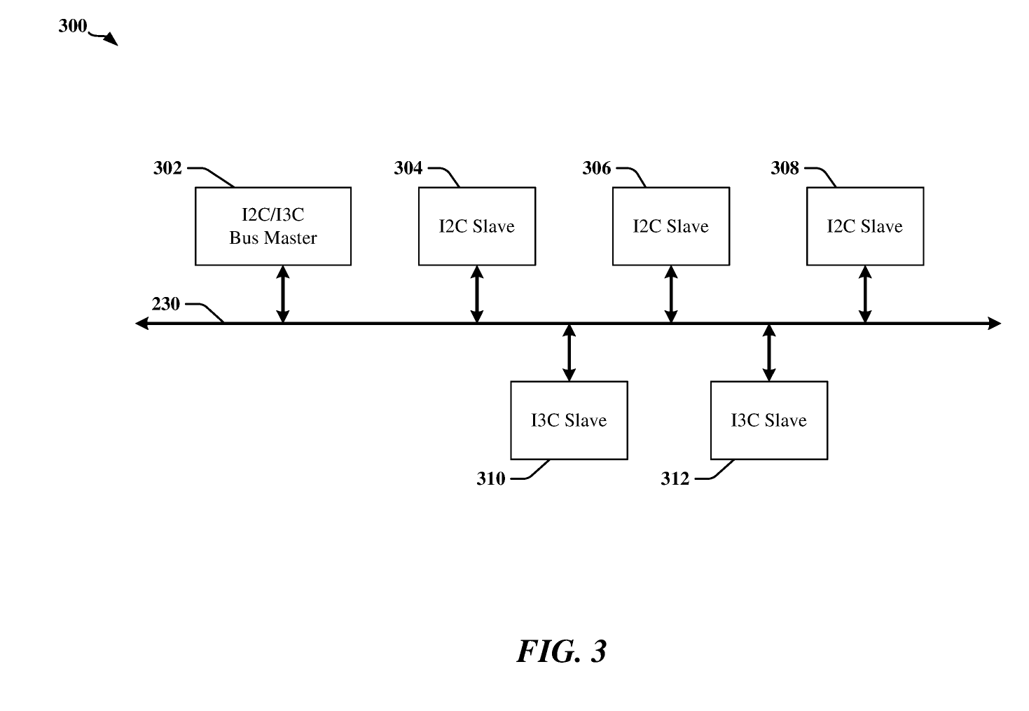

FIG. 3 illustrates a system 300 including a configuration of devices 302, 304, 306, 308, 310, and 312 connected to a 2-wire bus 230 that may support a plurality of communication protocols. Devices 302, 304, 306, 308, 310, and 312 may communicate using the 2-wire bus 230 by exchanging data on the data line 218 (see FIG. 2) when a clock signal is transmitted on the clock line 216. In the illustrated example, three slave devices 304, 306 and 308 are limited to communicating using I2C protocols over the 2-wire bus 230, while two slave devices 310 and 312 are adapted or configured to communicate using I3C protocols over the 2-wire bus 230. A single bus master device 302 may operate as a bus master in both I2C and I3C modes of operation.

The I3C-capable devices 302, 310 and 312 may coexist with the I2C-limited slave devices 304, 306 and 308 using I2C protocols. While multiple bus masters may be employed in I3C modes of operation, I2C protocols provide for a single bus master. In the example, a single bus master 302 can communicate in an I2C mode of operation and in an I3C mode of operation. One or more of the I3C-capable slave devices 310, 312 may also communicate using I2C protocols. For example, the bus master 302 may communicate with one of the I3C-capable slave devices 310 or 312 using I3C protocols to transfer high-volume or high-speed data, and may communicate low-volume information to the same I3C-capable slave device 310 or 312 using I2C protocols. In some instances, the bus master 302 may transmit certain control and configuration information using I2C protocols as a common method to broadcast messages to multiple slave devices 304, 306, 308, 310, and 312.

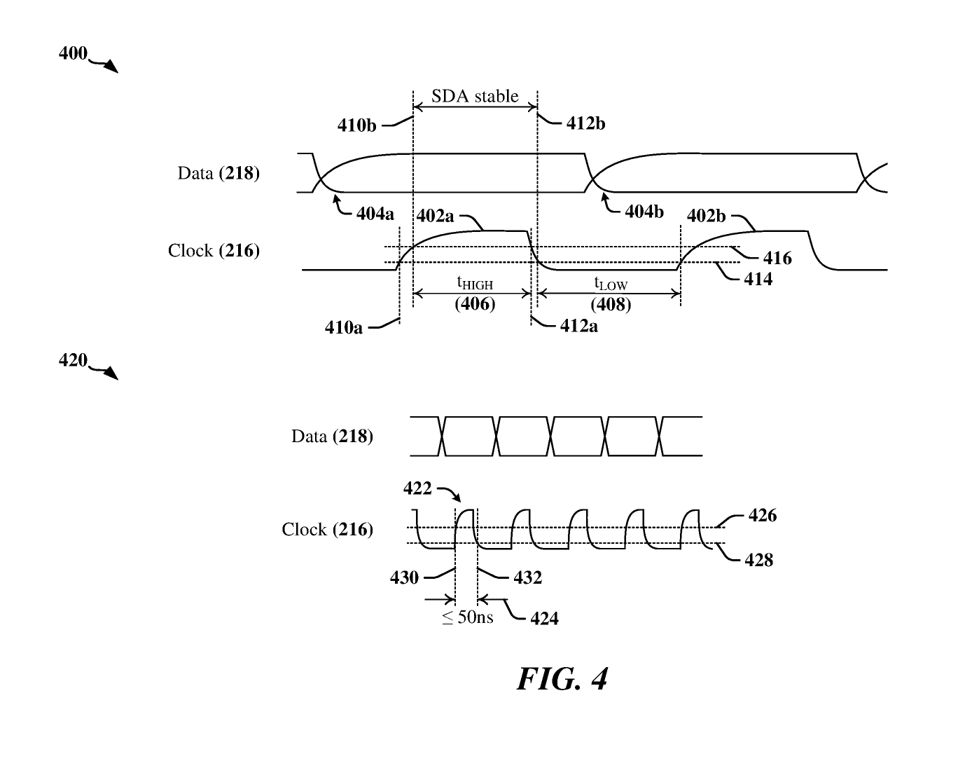

FIG. 4 provides timing diagrams 400, 420 illustrating the relationship between signals transmitted on the data line 218 and the clock line 216. The first timing diagram 400 illustrates timing consistent with I2C protocols, and relates to the timing relationship between the data line 218 and the clock line 216 while data is being transferred on the 2-wire bus 230. The clock line 216 provides a series of clocking pulses 402a, 402b that can be used to sample a data signal transmitted on the data line 218. When the clock line 216 is in a logic high state during data transmission, data on the data line 218 is required to be stable and valid, such that the state of the data line 218 is not permitted to change when the clock line 216 is in a high state. In a logic low state, receiving circuits ignore (or do not care about) the state of the data line 218.

Specifications for the I2C protocol (herein referred to as “I2C Specifications”) define a minimum duration for the high period (t_{HIGH}) 406 of each pulse 402a, 402b on the clock line 216. The high period 406 of the pulse 402a, 402b corresponds to the time in which the clock line 216 has a voltage greater than a threshold minimum voltage level 416, 426 for the high logic state. The I2C Specifications also define minimum durations for a setup time and a hold time associated with transitions in the pulse 402a, 402b, and during which the signaling state of the data line 218 must remain in the high logic state. The setup time defines a maximum time period after a transition 404a between signaling states on the data line 218 until the arrival of the rising edge of a pulse 402a, 402b on the clock line 216. The hold time defines a minimum time period after the falling edge of the pulse 402a, 402b on the clock line 216 until a next transition 404b between signaling states on the data line 218. The I2C Specifications also define a minimum duration for a low period (t_{LOW}) 408 for the clock line 216, when the voltage of the clock line 216 is below a threshold maximum value 414, 428 for the low logic state. The data on the data line 218 is typically captured in the high period 406, when the clock line 216 is in the high logic state after the leading edge of the pulse 402a, 402b.

The second timing diagram 420 illustrates timing consistent with I3C protocols, and relates to the timing relationship between the data line 218 and the clock line 216 while data is being transferred on the 2-wire bus 230 at higher data rates (e.g. 6-16 Mbps) than data rates typically available using I2C protocols (e.g., 0.1-3.2 Mbps). In the I3C example, a clock signal transmitted on the clock line 216 includes a series of pulses, as illustrated by the pulse 422, that can be used to sample a data signal transmitted on the data line 218. Each pulse 422 transmitted on the clock line 216 during I3C modes of operation may have a pulse width 424 that is 50 ns or less from initial transition 430 from the low logic state until return 432 to the low logic state. Coexistence of slave devices 304, 306, 308, 310, and 312 can be accomplished when the I2C-limited slave devices 304, 306 and 308 comply with I2C protocols and filter or ignore pulses 422 transmitted during I3C transactions on the 2-wire bus 230 with a duration of 50 ns or less.

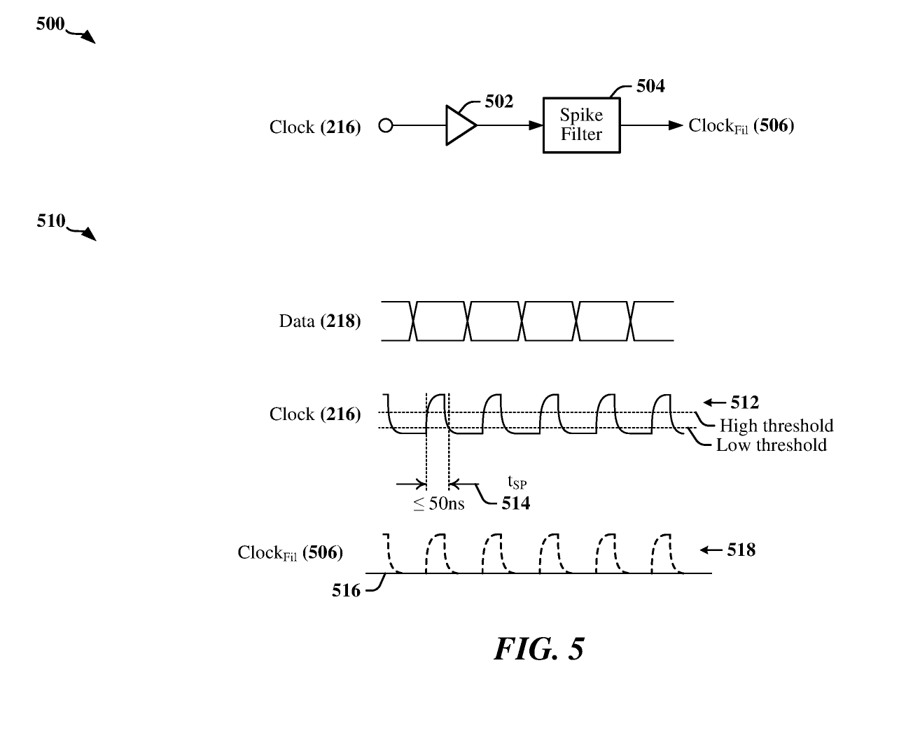

FIG. 5 is a diagram that illustrates the operation of I2C-limited slave devices 304, 306 and 308 during I3C modes of operation. In accordance with I2C protocols, an input circuit 500 of an I2C-limited slave device 304, 306, 308 includes a spike filter 504 that filters signals received from the clock line 216 by a line receiver 502. The spike filter 504 produces a filtered serial clock signal (Clock_{Fil} 506) that is used by the I2C-limited slave device 304, 306, 308 to sample the signal transmitted on the data line 218. The spike filter 504 may be adapted or configured to filter any pulses on the clock line 216 that have a duration 514 (t_{SP}) of 50 ns or less.

The timing diagram 510 in FIG. 5 illustrates timing of signals on the clock line 216, data line 218, and Clock_{Fil} 506 when the 2-wire bus 230 is operated in accordance with an I3C mode of operation. In I3C modes of operation, the pulses 512 on the clock line 216 have a duration 514 of 50 ns or less and are filtered by the spike filters 504 of I2C-limited slave devices 304, 306, 308. The Clock_{Fil} 506 output by the spike filters 504 may remain at a low logic level 516 (e.g., 0 Volts) for the duration of data transfers in the I3C mode of operation. In the timing diagram 510, occurrences of the pulses 512 received from the clock line 216 that are filtered by the spike filter 504 are shown as broken line pulses 518 in the Clock_{Fil} 506.

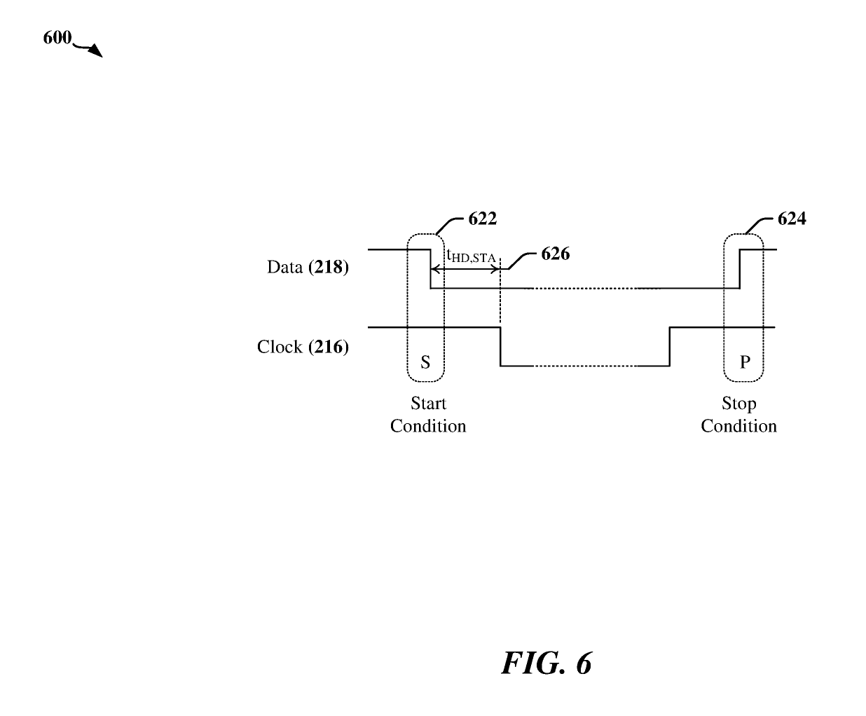

FIG. 6 is a timing diagram 600 that illustrates timing of signaling states on the data line 218 and the clock line 216 used to initiate and terminate transmissions on the 2-wire bus 230. Start conditions 622 and stop conditions 624 are recognized in I2C and I3C modes of operation. A start condition 622 is used by the bus master 302 to signal that data is to be transmitted. The start condition 622 occurs when the data line 218 transitions from high to low while the clock line 216 is high. In I2C modes of operation, the bus master 302 transmits the start condition 622. The master device 302 then transmits a clock signal on the clock line 216 and data is exchanged over the data line 218. Transmission is completed when a stop condition 624 is transmitted by the master device 302. The stop condition 624 occurs when the data line 218 transitions from low to high while the clock line 216 is high. The I2C Specifications require that all transitions of the data line 218 occur when the clock line 216 is low, and exceptions may be treated as a start condition 622 or a stop condition 624.

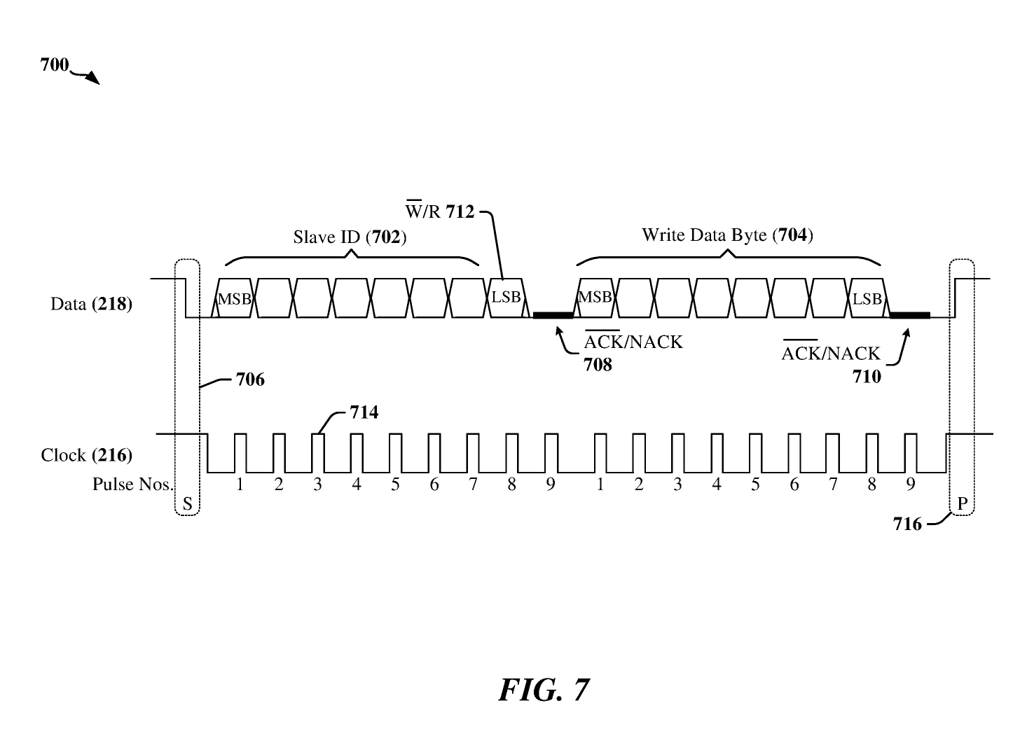

FIG. 7 is a timing diagram 700 illustrating a byte write data operation in accordance with I2C protocols. The write operation commences after the start condition 706, and is terminated by the stop condition 716. An I2C master node sends a 7-bit slave address, which may be referred to as a slave identifier (Slave ID 702) on the data line 218. The Slave ID 702 indicates which slave node on the I2C bus the master node wishes to access. The Slave ID 702 is followed by a Read/Write bit 712 that indicates whether the operation is a read or a write operation. In this example, the Read/Write bit 712 is at logic 0 to indicate a write operation; for a read operation the Read/Write bit 712 is at logic 1. Only the slave node that has an address that matches the Slave ID 702 can respond to the write (or read) operation. In order for an I2C slave node to detect its own Slave ID 702, the master node transmits at least 8 bits on the data line 218, together with 8 clock pulses transmitted on the clock line 216 (including the pulse 714). The I2C protocol provides for transmission of 8-bit data (bytes) 704 and 7-bit slave addresses (e.g. Slave ID 702). Data transmissions are acknowledged when the receiver drives the data line 218 for one clock period 708, 710, and a low signaling state represents an acknowledgement (ACK) indicating successful reception, while a high signaling state represents a negative acknowledgement (NACK) indicating a failure to receive, or occurrence of an error during reception.

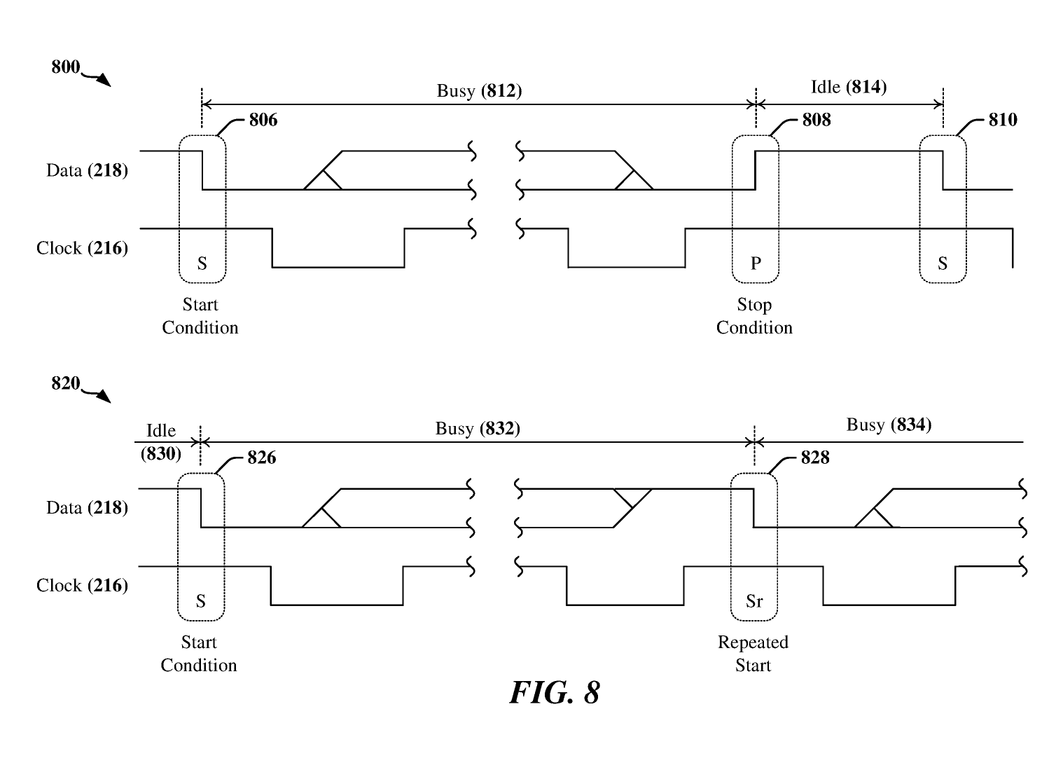

FIG. 8 includes timing diagrams 800 and 820 that illustrate timing associated with multiple frame transmissions on the 2-wire bus 230. A frame may include one or more bytes of data transmitted between a start condition 806 and stop condition 808. The 2-wire bus 230 may be considered to be busy in the interval between the start condition 806 and the stop condition 808. The 2-wire bus 230 may be considered to be idle after a stop condition 808 is transmitted and before the next the start condition 806. In some instances, the duration of the idle period 814 between a stop condition 808 and a consecutive start condition 810 may be prolonged, causing decreased data throughput. In operation, a busy period 812 commences when the bus master 302 transmits a first start condition 806, followed by data. The busy period 812 ends when the bus master 302 transmits a stop condition 808 and an idle period 814 ensues. The idle period 814 ends with transmission of a second start condition 810.

With reference also to the timing diagram 820, in some instances, the idle periods 814 between successive frame transmissions on the 2-wire bus 230 may be reduced in number and/or eliminated in some circumstances by transmitting a repeated start condition (Sr) 828 rather than a stop condition. The repeated start condition 828 terminates the preceding frame transmission and simultaneously indicates the commencement of a next frame transmission. The state transition on the data line 218 is identical for a start condition 826 occurring after an idle period 830 and the repeated start condition 828. That is, the data line 218 transitions from high to low while the clock line 216 is high. When a repeated start condition 828 is used between frame transmissions, a first busy period 832 is immediately followed by a second busy period 834.

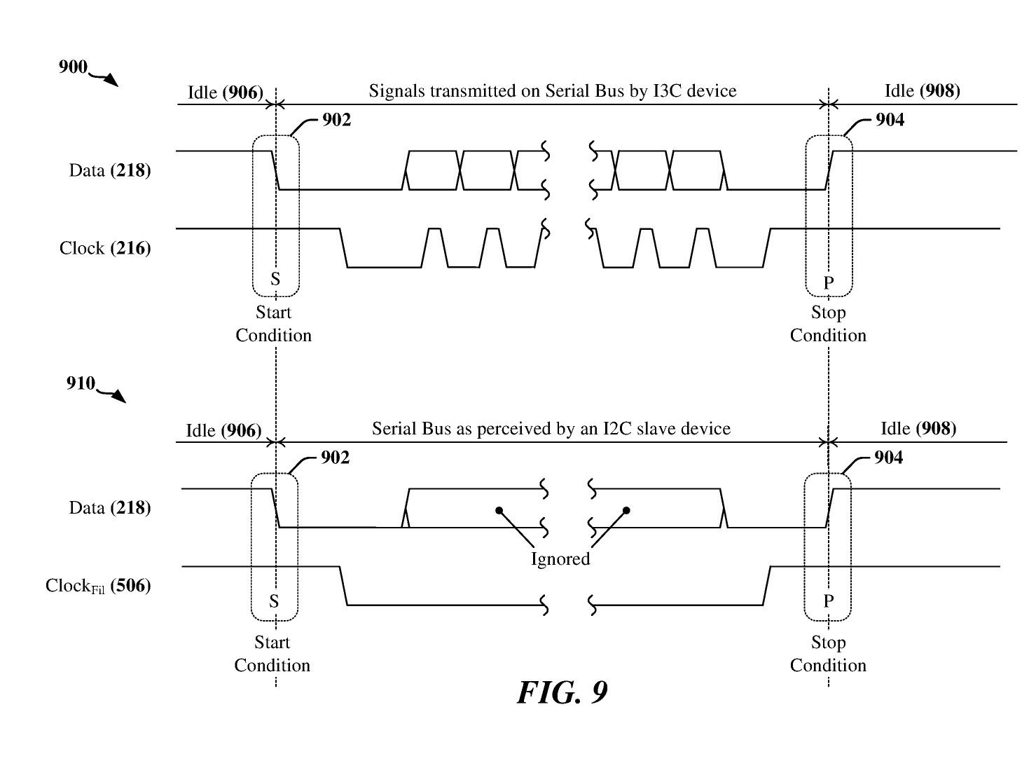

FIG. 9 includes timing diagrams 900, 910 related to signaling states on the data line 218 and the clock line 216 when the 2-wire bus 230 is operated in accordance with an I3C mode of operation. With reference to the first timing diagram 900, data is transmitted at higher data rates in the I3C mode of operation than in I2C modes of operation, and the clock signal transmitted on the clock line 216 includes pulses that have a duration of 50 ns or less (see FIG. 4). An I3C-capable slave device 302, 310, 312 may sample the data line 218 using the clock signal on the clock line 216. The second timing diagram 910 illustrates the 2-wire bus 230 as perceived by an I2C-limited slave device 304, 306, 308 that employs a spike filter 504 (see FIG. 5) to remove pulses of 50 ns or less from the clock line 216. The I2C-limited slave device 304, 306, 308 uses a modified clock signal (Clock_{Fil} 506) output by the spike filter 504 to sample the data line 218. Pulses in I3C clock signals are effectively suppressed in Clock_{Fil} 506 except for start conditions 902 and stop conditions 904, since the I3C clock signal includes pulses that have a duration of 50 ns or less. According to I2C protocols, the state of the data line 218 is considered to be “don't care” when the clock line 216 is low. Accordingly, data transmissions in the signal received from the data line 218 by the I2C-limited slave device 304, 306, 308 are ignored during I3C modes of operation when the Clock_{Fil} 506 remains in logic low state due to the spike filter 504 suppressing the 50 ns or less I3C clock pulses on clock line 216.

### Common Command Codes

The I3C bus may be operated as a serial, hierarchical, multi-master, multi-drop, two-wire link. The I3C serial bus supports transactions in which a data payload is bookended by bus management commands Bus management commands may be referred to as Common Command Codes (CCCs). The data payload can be transferred using one of several available data transfer protocols, including Single Data Rate (SDR) protocol, a High Data Rate (HDR) protocol, and variants of the HDR protocol including HDR at Double Data Rate, HDR using Ternary Symbols Legacy (HDR-TSL) and HDR using Ternary Symbols Pure (HDR-TSP). In HDR-DDR mode, a bit of data is transmitted on both the rising edge and falling edge of clock pulses. In HDR-TSL and HDR-TSP modes, both wires of the two-wire bus are used to encode data, and the data payload is encoded in ternary symbols that represent the signaling state of the two wires. The data transfer protocols may use different configurations of the same hardware components to offer significantly different data throughput, from simple SDR to HDR-TSP which can be three times faster), all using essentially the same hardware. In general, the SDR protocol manipulates bytes, whereas the HDR protocols work with two-byte words.

In conventional use, CCCs are transferred over the I3C bus using the SDR protocol. In order to transmit CCCs, the master and slave devices are configured for SDR mode and the CCCs are transmitted at the lower data rate in order to support coexistence of high-speed and low-speed devices on the I3C bus. In SDR modes the CCCs have a length of 1 byte (8 bits) and are transmitted with a parity check bit, which may be referred to as the T bit.

HDR protocols also provide for the exchange of command codes at HDR speeds. According to conventional HDR protocols, command codes are combined with a Slave Address within two-byte word. The two-byte word also includes supplementary control bits. The number of bits available for command codes in conventional HDR implementations is limited to 7 bits or less.

Certain aspects disclosed herein enable CCCs encoded for SDR mode to be transmitted using HDR protocols. The ability to transmit CCCs in HDR modes using the 8-bit codes defined for the CCCs in SDR mode can improve signaling efficiency and provide other benefits. For example, commands can be processed in multiple modes using the same digital code structure and/or assignments. In another example, the two-wire link can be operated in HDR mode without exit to an SDR mode for the purposes of transmitting a CCC. Bus throughput can be increased when the turnaround time between modes of operation is eliminated.

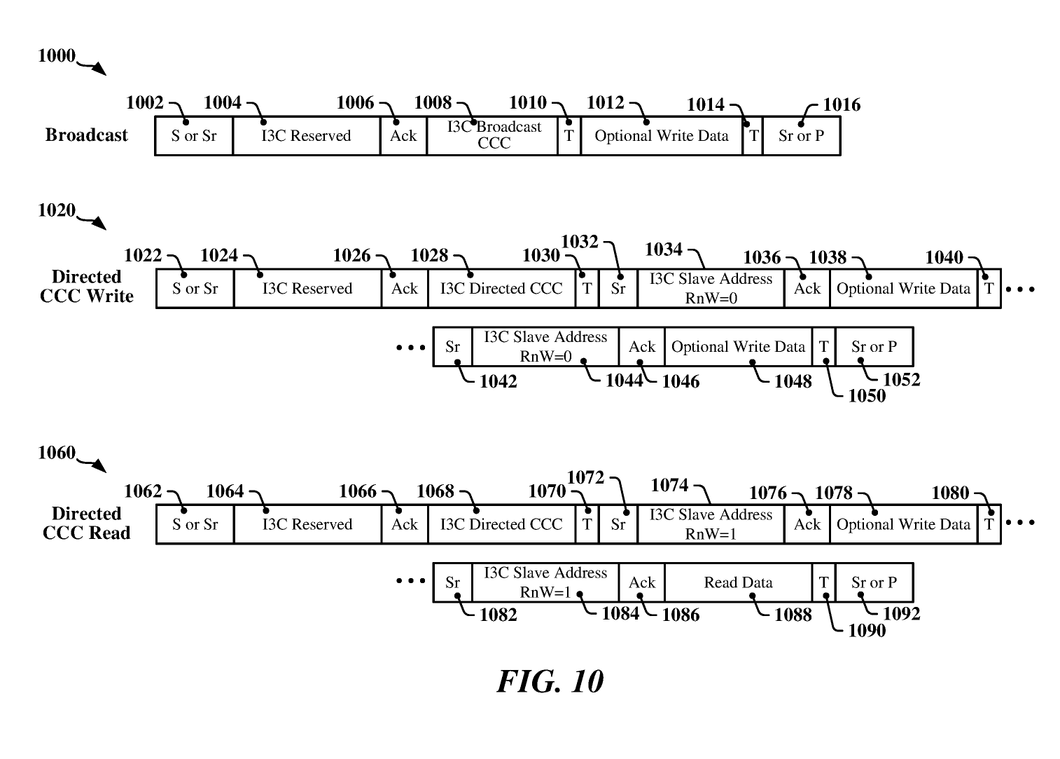

FIG. 10 illustrates examples of CCC transmissions over a serial data link configured to support the HDR mode of operation. The CCC transmission is performed in SDR mode, and the CCC is preceded by the transmission of an I3C reserved byte, which is {7′h7E, RnW=0}.

The first example relates to a CCC broadcast 1000. The CCC broadcast 1000 is initiated by transmitting a start or repeated start 1002 followed by a reserved I3C word 1004. If an acknowledgement 1006 is received, an I3C CCC command 1008 may be transmitted followed by a parity check bit 1010. The I3C CCC command 1008 may be up to 8 bits in length. When the I3C CCC command 1008 is a write command, write data 1012 may be transmitted with a parity bit 1014. The CCC broadcast 1000 is terminated when a repeated start or stop 1016 is transmitted.

The second example relates to a CCC directed write 1020. The CCC directed write 1020 is initiated by transmitting a start or repeated start 1022 followed by a reserved I3C word 1024. If an acknowledgement 1026 is received, an I3C CCC directed command 1028 may be transmitted followed by a parity check bit 1030. The I3C CCC directed command 1028 may be up to 8 bits in length. Data may then be transmitted. Each data payload commences with a repeated start 1032, 1042 followed by an I3C slave address 1034, 1044 with the read/not-write (RnW) bit set to 0 to indicate a write operation. Upon receiving an acknowledgement 1036, 1046, write data 1038, 1048 may optionally be transmitted with a parity bit 1040, 1050. The CCC directed write 1020 is terminated with transmission of a repeated start or stop 1052.

The third example relates to a CCC directed read 1060. The CCC directed read 1060 is initiated by transmitting a start or repeated start 1062 followed by a reserved I3C word 1064. If an acknowledgement 1066 is received, an I3C CCC directed command 1068 may be transmitted followed by a parity check bit 1070. The I3C CCC directed command 1068 may be up to 8 bits in length. Data may then be read from a slave device. Each data payload commences with a repeated start 1072, 1082 followed by an I3C slave address 1074, 1084 with the RnW bit set to 1 to indicate a read operation. Upon receiving an acknowledgement 1076, 1086, read data 1078, 1088 may be received with a parity bit 1080, 1090. The CCC directed read 1060 is terminated with transmission of a repeated start or stop 1092.

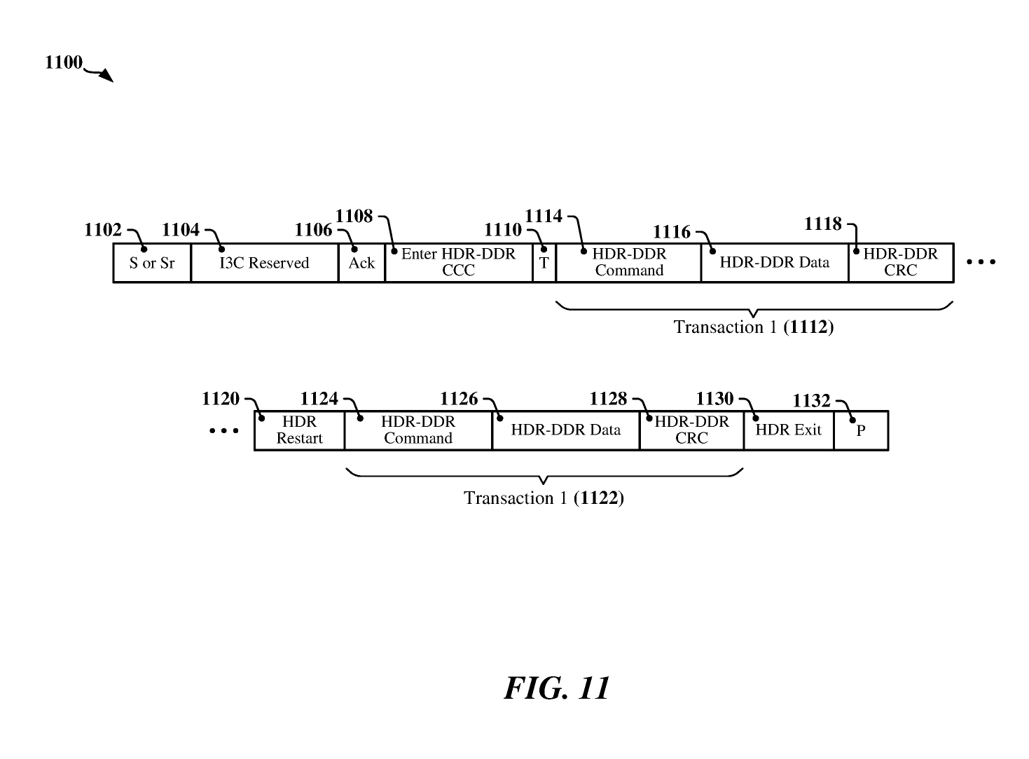

FIG. 11 illustrates an example of an CCC transmission 1100 on a serial data link configured to support the HDR-DDR mode of operation in accordance with certain aspects disclosed herein. The CCC transmission 1100 is initiated in SDR mode, and the CCC is preceded by the transmission of an I3C reserved word 1104, which is {7′h7E, RnW=0}. In the HDR-DDR mode of operation, data is transferred in HDR-DDR words with a 20-bit length. The first two bits of the HDR-DDR word is a preamble, which is followed by 16 bits that carry two bytes of data, with the final two bits serving as parity check bits.

The CCC transmission 1100 is initiated by transmitting a start or repeated start 1102 followed by the reserved I3C word 1104. When an acknowledgement 1106 is received, an Enter HDR-DDR CCC command 1108 is transmitted to cause the bus to enter the HDR-DDR mode of operation, followed by a transition bit 1110. One or more HDR-DDR transactions 1112, 1122 may be transmitted, separated by HDR restart sequences 1120. Each HDR-DDR transaction 1112, 1122 includes an HDR-DDR command code 1114, 1124 and HDR-DDR data word 1116, 1126 with an HDR-DDR cyclic redundancy check (CRC) value 1118. The CCC transmission 1100 is terminated when an SDR mode stop 1132 is transmitted. The HDR-DDR command code 1124 immediately follows an HDR Restart sequences 1120, which indicate that the next HDR-DDR word 1126 is a Command Code.

TABLE 1

| Word | Preamble | Payload | Parity | | |
|---|---|---|---|---|---|
| Type | 2 bits | 16 bits | 1b | 1b | Notes |
| Command | 2′b01 | 15:8 - Command | P1 | P0 | Command may |
| | | 7:1 - Slave Addr. | | | follow only Enter |
| | | 0 - Reserved | | | HDR or HDR |
| | | | | | Restart. |
| | | | | | Command Codes: |
| | | | | | Write: 0x00 to 0x7F |
| | | | | | Read: 0x80 to 0xBF |
| Data | 2′b10 | 15:0 Data Bits | P1 | P0 | 0 or more Data |
| | 2′b11 | | | | words may follow |
| | | | | | Command. |
| | | | | | Only CRC |
| | | | | | may follow Data. |
| CRC | 2′b01 | 15:12 - 0xC | Not | | CRC value ends |
| | | 11:6 - CRC5 | Used | | at bit 5, then HDR |
| | | 5 - Restart/Exit | | | Restart or HDR Exit |
| | | 4:0 - Not Used | | | begins. Parity is |
| | | | | | not used. |
| Reserved | 2′b01 | 15:12 0xD to 0xF | P1 | P0 | Reserved |
| | | 11:0 Reserved | | | |

| | | |
|---|---|---|
| — | 2′b00 | Preamble value 2′b00 not used |

Table 1 illustrates the format of various data types in an HDR-DDR transmission. The HDR-DDR command code 1114, 1124 transmitted in HDR-DDR mode is provided in fewer bits than permitted for a CCC (e.g. the Enter HDR-DDR CCC command 1108) transmitted in SDR mode. Table 2 illustrates certain bit assignments used for coding HDR-DDR command code 1114, 1124.

TABLE 2

| | | Size | |
|---|---|---|---|
| Bits | Field | (bits) | Notes |
| 15 | Read/Write | 1 | 1 = Read (Slave to Master) |
| | | | 0 = Write (Master to Slave) |
| | | | This can be determined from a |
| | | | top nibble value of 0x8 to 0xB. |
| 14:8 | Command Code | 7 | 128 possible Write commands, |
| | | | 128 possible Read commands. |
| 7:1 | Slave Address | 7 | Same Dynamic Address as used in |
| | | | I3C SDR Protocol |
| 0 | Write Reserved | 1 | For Read, Ensures that P0 is 1 |
| | Read Parity | | (Allows easier handoff) |
| | Adjustment | | |

Command codes can be defined for use in serial data links configured for HDR-TSL or HDR-TSP modes of operation. In the HDR-TSL or HDR-TSP modes of operation, data is transferred in words that have an 18-bit length. Of those 18 bits, the first 16 are two bytes of data and the last two are parity check bits.

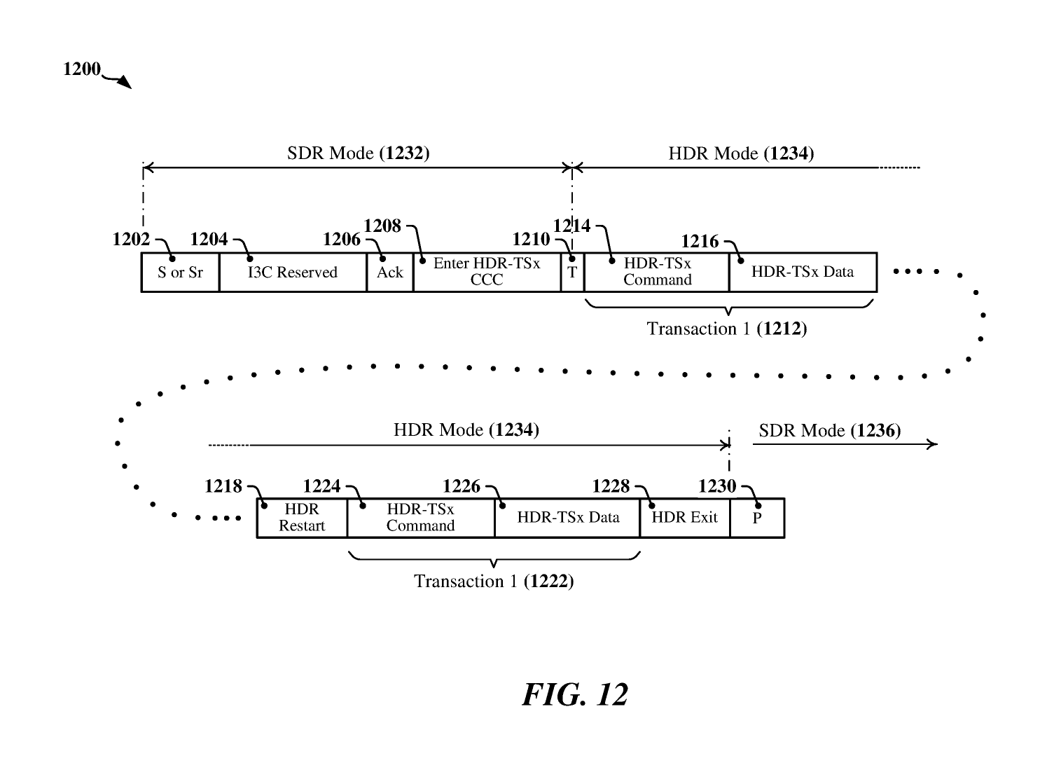

FIG. 12 illustrates an example of a CCC transmission 1200 on a serial data link configured to support the HDR-TSL or HDR-TSP (collectively, HDR-TSx) modes of operation. The CCC transmission 1200 is initiated in SDR mode of operation 1232, and the CCC is preceded by the transmission of an I3C reserved word 1204, which may be {7′h7E, RnW=0}. In HDR-TSx modes of operation, data is transferred in HDR-TSx words with an 18-bit length. The first 16 bits of the HDR-TSx word carry two bytes of data, with the final two bits serving as parity check bits.

The CCC transmission 1200 is initiated by transmitting a start or repeated start 1202 followed by the I3C reserved word 1204. When an acknowledgement 1206 is received, an Enter HDR-TSx CCC command 1208 is transmitted to cause the bus to enter the HDR-TSx mode of operation 1234, followed by a transition bit 1210. One or more HDR-TSx transactions 1212, 1222 may be transmitted in the HDR-TSx mode of operation 1234, separated by HDR restart sequences 1218. Each HDR-TSx transaction 1212, 1222 includes an HDR-TSx command code 1214, 1224 and HDR-TSx data word 1216, 1226. The CCC transmission 1200 is terminated when an SDR mode stop 1230 is transmitted indicating return to an SDR mode of operation 1236. The HDR-TSx command codes 1214, 1224 immediately follow HDR Restart sequences 1218, which indicate that the next HDR-TSx data word 1216, 1226 is a Command Code. The HDR-TSx command code 1214, 1224 transmitted in HDR-TSx mode is transmitted in the same format as the HDR-DDR command codes 1114, 1124, and are provided in fewer bits than permitted for a CCC (e.g. the Enter HDR-DDR CCC command 1208) transmitted in SDR mode. The format of the 16 bits of the HDR-TSx data word 1216, 1226 has the same format as transmitted in the HDR-DDR data word 1116, 1126. The bit assignment on command codes in HDR-TSL and HDR-TSP modes is shown in Table 3.

TABLE 3

| | | Size | |
|---|---|---|---|
| Bits | Field | (bits) | Notes |
| 15 | Read/Write | 1 | 1 = Read (Slave to Master) |
| | | | 0 = Write (Master to Slave) |
| 14:8 | Command Code | 7 | 128 possible Write Commands, |
| | | | 128 possible Read Commands |
| 7:1 | Slave Address | 7 | Same Dynamic Address used in I3C |
| | | | SDR Protocol |
| 0 | Reserved | 1 | Reserved |

### Transmitting CCCs Without Exiting I3C HDR Modes

Certain aspects disclosed herein enable the communication of CCCs without leaving HDR-DDR, HDR-TSP and/or HDR-TSL modes of operation. In conventional implementations, a master device initiates transmission of a CCC in the SDR mode of operation 1232, 1236. According to I3C bus specifications, a limited number of bits is provided for command codes transmitted in HDR protocols. The HDR commands are restricted to integer numbers in the range 0x00-0x7F for write commands and to integer numbers in the range 0x80-0xBF for read commands. The code space allocated for HDR commands cannot accommodate all of the CCC codes, which have an 8-bit length.

According to certain aspects disclosed herein, codes used for representing CCCs transmitted in SDR mode can be transmitted in HDR modes. In one example, a CCC is included within a supplementary word transmitted as part of an I3C HDR command. The inclusion of the supplementary word provides sufficient code space for CCCs, while maintaining the normative format for HDR general command codes. A CCC that is coded for, and transmitted in low-speed SDR mode may be referred to herein as an SDR-CCC. A CCC that is coded for low-speed SDR mode and transmitted in I3C high-speed DDR mode may be referred to herein as an HDR-DDR CCC. A CCC that is coded for low-speed SDR mode and transmitted in I3C high-speed TSx mode may be referred to herein as an HDR-TSx CCC.

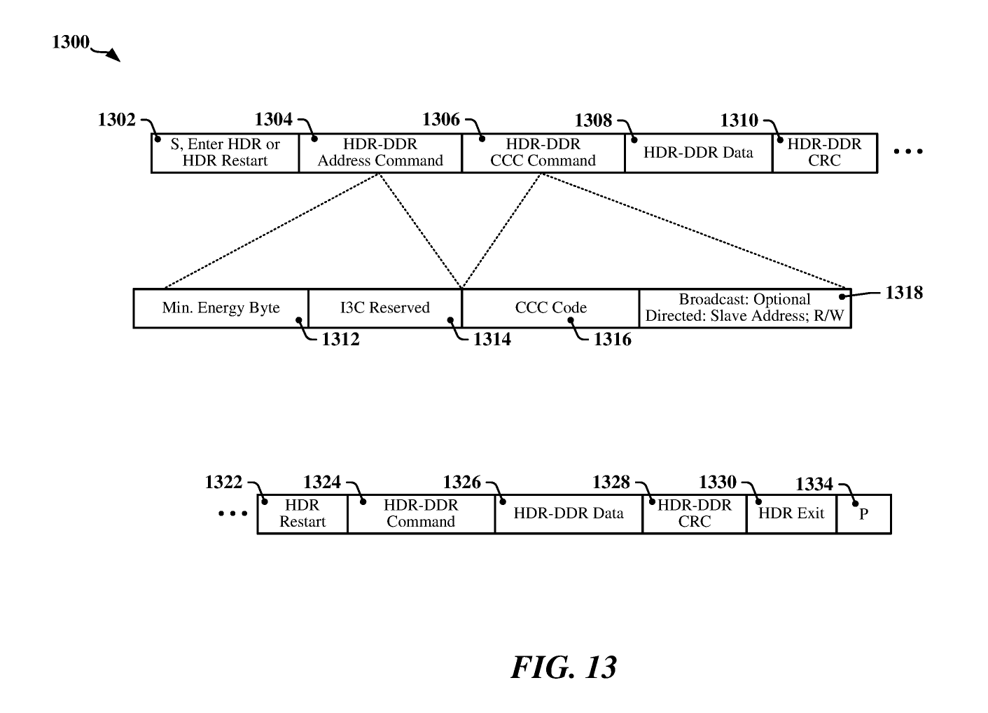

FIG. 13 illustrates an example of an HDR-DDR transmission 1300 that includes transmission of a CCC in accordance with certain aspects disclosed herein. The HDR-DDR transmission 1300 may commence with a start sequence 1302, which may be an HDR Restart or a sequence initiated from an SDR mode by transmitting an SDR start and an HDR Enter command in SDR mode. An HDR-DDR command word 1304 is transmitted to indicate that a HDR-DDR CCC command 1306 follows. The HDR-DDR command word 1304 may include an invalid slave address, such as 7′h7E, that is not a valid slave address, followed by the HDR-DDR CCC command code 1306. The HDR-DDR CCC command code 1306 may include a command that is encoded for transmission in SDR mode (i.e., an SDR-CCC). Devices coupled to the I3C bus may be adapted to recognize the invalid slave address as a precursor to an SDR-CCC. The adapted devices may then respond to the SDR-CCC as appropriate or as defined by I3C specifications and/or protocols.

The HDR-DDR command word 1304 may have its reserved bit (see Table 3) set to “0” to match the frame of the CCC. That is, the 7′h7E reserved address is followed by a 0. The HDR-DDR CCC command 1306 includes the SDR-CCC command organized as a data word. In one example, the first byte of the word in the HDR-DDR CCC command 1306 is the SDR-CCC, which may inherently indicate whether the SDR-CCC relates to a broadcast or directed command. The second byte of the word in the HDR-DDR CCC command 1306 may include optional data if the SDR-CCC is indicated to be a broadcast CCC. As specified or indicated by the SDR-CCC, other data bytes be provided in the next transmitted word (HDR-DDR data 1308). The second byte of the word in the HDR-DDR CCC command 1306 may include optional data if the SDR-CCC is indicated to be a directed write CCC, where a slave address is provided and the read/write bit is appropriately configured. As specified or indicated by the SDR-CCC, other data bytes be provided in the next transmitted word (HDR-DDR data 1308). When the SDR-CCC is indicated to be a directed read CCC, a bus turnaround sequence is performed as defined by I3C specifications or protocols.

When an SDR-CCC command is indicated by the use of an invalid slave address, certain bits of the HDR-DDR command word 1304 may be ignored. For example, the command field 1312 (bits [15:8]) of the HDR-DDR command word 1304 includes a read command or write command in normal command words, when the address field 1314 is set to a valid slave devices or to a broadcast address. These bits are typically of no importance when an HDR-DDR CCC command 1306 is transmitted. When bits of the HDR-DDR command word 1304 can be ignored, any value can be transmitted. According to certain aspects, the ignored bits of the command field 1312 can be populated with a value calculated to consume the minimum, least or reduced energy during transmission. In one example, a minimum-energy byte may be defined as having the value 0xFF, which results in the clock line 216 toggling, while the data line 218 is kept in a high signaling state.

One or more HDR-DDR transactions may be transmitted in the HDR-DDR mode of operation, separated by HDR restart sequences 1322. Each HDR-DDR transaction includes an HDR-DDR command code 1304, 1324 and HDR-DDR data word 1308, 1326. HDR-DDR transactions may include an HDR-DDR CRC byte 1310, 1328. The HDR-DDR transmission 1300 is terminated after an HDR Exit 1330 is transmitted and after an SDR mode stop 1334 is signaled indicating return to an SDR mode of operation.

The HDR-DDR transmission 1300 may be employed in a variety of implementations. In one example, all of the devices coupled to the I3C bus may be capable of operating in HDR-DDR mode and the use of the HDR-DDR transmission 1300 to carry SDR-CCCs at HDR-DDR data rates can improve overall bus throughput by reducing or eliminating the need to switch between SDR and HDR-DDR modes. In another example, a processing circuit or IC device may include multiple components that communicate through a common I3C port or multiple ports capable of HDR-DDR operation, and the use of the HDR-DDR transmission 1300 to carry SDR-CCCs at HDR-DDR data rates can improve overall bus throughput by reducing or eliminating the need to switch between SDR and HDR-DDR modes for internal communication.

In another example, an I3C bus may be used to communicate between HDR-DDR capable devices and legacy I2C devices coupled to a common serial bus and/or or I3C devices that communicate over a common serial bus using different protocols. In this example, the number of transitions to and from HDR-DDR mode can be reduced when a sequence of transactions is executed between multiple devices that support HDR-DDR modes of operation. For example, a master device may communicate SDR-CCCs to a plurality of HDR-DDR capable slave devices without dropping out of HDR-DDR mode and into SDR mode to transmit the codes corresponding to the SDR-CCC.

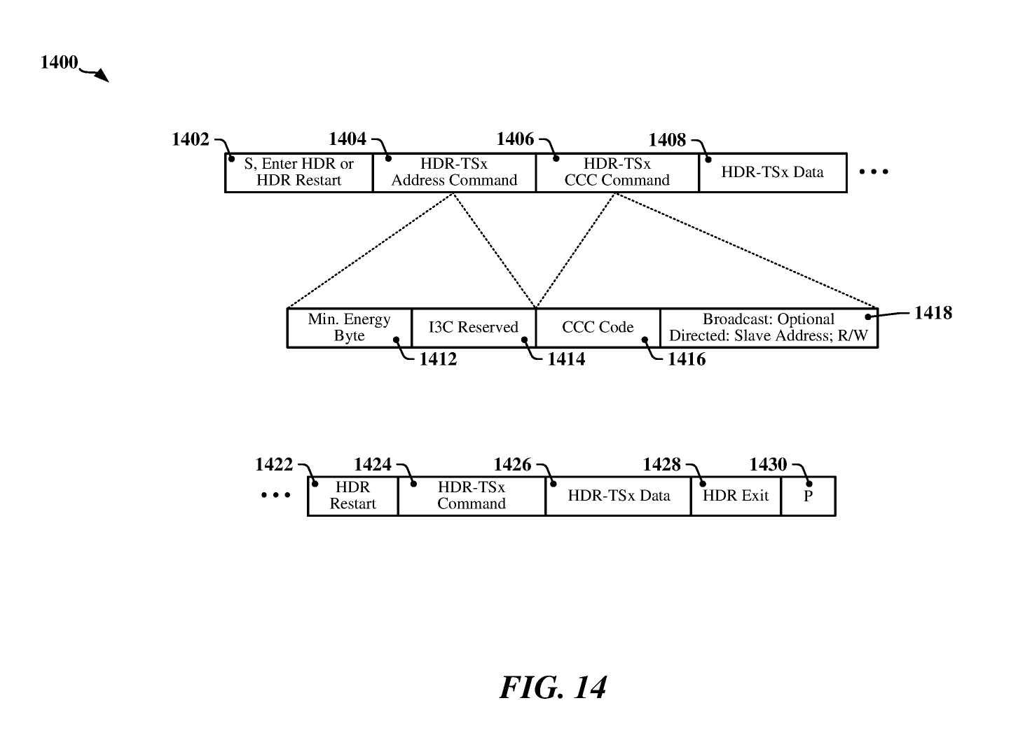

FIG. 14 illustrates an example of an HDR-TSx transmission 1400 that includes a CCC in accordance with certain aspects disclosed herein. The HDR-TSx transmission 1400 may commence with a start sequence 1402, which may be an HDR Restart or a sequence initiated from an SDR mode by transmitting an SDR start and an HDR Enter command in SDR mode. An HDR-TSx command word 1404 is transmitted to indicate that a HDR-TSx CCC command 1406 follows. The HDR-TSx command word 1404 may include a slave address, such as 7′h7E, that is not a valid slave address. The HDR-TSx CCC command code 1406 may include a command that is encoded for transmission in SDR mode (i.e., an SDR-CCC), and devices coupled to the I3C bus may be adapted to recognize the invalid slave address as a precursor to an SDR-CCC.

The HDR-TSx command word 1404 may have its reserved bit (see Table 3) set to “0” to match the frame of the CCC. That is, the 7′h7E reserved address is followed by a 0. The HDR-TSx CCC command 1406 includes the SDR-CCC command organized as a data word. In one example, the first byte of the word in the HDR-TSx CCC command 1406 is the SDR-CCC, which may inherently indicate whether the SDR-CCC relates to a broadcast or directed command. The second byte of the word in the HDR-TSx CCC command 1406 may include optional data if the SDR-CCC is indicated to be a broadcast CCC. As specified or indicated by the SDR-CCC, other data bytes be provided in the next transmitted word (HDR-TSx data 1408). The second byte of the word in the HDR-TSx CCC command 1406 may include optional data if the SDR-CCC is indicated to be a directed write CCC, where a slave address is provided and the read/write bit is appropriately configured. As specified or indicated by the SDR-CCC, other data bytes be provided in the next transmitted word (HDR-TSx data 1408). When the SDR-CCC is indicated to be a directed read CCC, a bus turnaround sequence is performed defined by I3C specifications.

When a SDR-CCC command is indicated by the use of an invalid slave address, certain bits of the HDR-TSx command word 1404 may be ignored. For example, the command field 1412 (bits 115:81) of the HDR-TSx command word 1404 includes a read command or write command in normal command words, when the address field 1414 is set to a valid slave devices or to a broadcast address. These bits are typically of no importance when an HDR-TSx CCC command 1406 is transmitted. When bits of the HDR-TSx command word 1404 can be ignored, any value can be transmitted. According to certain aspects, the ignored bits of the command field 1412 can be populated with a value calculated to consume the minimum, least or reduced energy during transmission. In an HDR-TSL example, the minimum-energy byte may be selected as a combination of ternary symbols that includes a combination of “1” or “2” symbols, in order to cause only one line to change signaling state. In one example, a combination may be {3′b100, 3′b100, 2′b10, 7′h7E, 1′b1, 1′bP1, 1′bP0} which results in ternary symbols: {2′T11, 2′T11, 2′T12, 2′T21, 2′T20, 2′T21}. In this example, only one of 12 symbols results in both lines toggling, with most of the toggling occurring on the clock line 216, with a consequence that HDR-TSL encoder adds the least number of dummy symbols.

One or more HDR-TSx transactions may be transmitted in the corresponding HDR-TSx mode of operation, separated by HDR restart sequences 1422. Each HDR-TSx transaction includes an HDR-TSx command code 1404, 1424 and HDR-TSx data word 1408, 1426. The HDR-TSx transmission 1400 is terminated after an HDR Exit 1428 is transmitted, and after an SDR mode stop 1430 is signaled indicating return to an SDR mode of operation.

The HDR-TSx transmission 1400 may be employed in a variety of implementations. In one example, all of the devices coupled to the I3C bus may be capable of operating in HDR-TSx mode and the use of the HDR-TSx transmission 1400 to carry SDR-CCCs at HDR-TSx data rates can improve overall bus throughput by reducing or eliminating the need to switch between SDR and HDR-TSx modes. In another example, a processing circuit or IC device may include multiple components that communicate through a common I3C port or multiple ports capable of HDR-TSx operation, and the use of the HDR-TSx transmission 1400 to carry SDR-CCCs at HDR-TSx data rates can improve overall bus throughput by reducing or eliminating the need to switch between SDR and HDR-TSx modes for internal communication.

In another example, an I3C bus may be used to communicate between HDR-TSx capable devices and legacy I2C devices coupled and/or or I3C devices that communicate using different protocols. In this example, the number of transitions to and from HDR-TSx mode can be reduced when a sequence of transactions is executed between multiple devices that support HDR-TSx modes of operation. For example, a master device may communicate SDR-CCCs to a plurality of HDR-TSx capable slave devices without dropping out of HDR-TSx mode and into SDR mode to transmit the codes corresponding to the SDR-CCC.

According to certain aspects, the use of a minimum-energy byte may be extended beyond the population of the command fields 1312, 1412 to include other optional fields or bytes transmitted in HDR modes. For example, broadcasts may include one or more optional or ignored fields that are of no significance when CCC codes are transmitted in HDR modes of communication. procedure, the first idea was to use the least amount of energy for transmitting them.

For example, certain SDR-CCC codes 1316, 1416 transmitted in HDR modes of operation may correspond to broadcasted CCCs in which the second byte 1318, 1418 is considered optional or otherwise ignored. Such optional or ignored bytes or fields can be populated with a minimum-energy byte or portion thereof.

According to certain aspects, optional fields or bytes occurring in transactions associated with the transmission of SDR-CCC codes in HDR modes of operation may be populated supplementary information. For example, unused fields of an HDR CCC transaction carry information used for error detection and/or correction procedures. The information may include CRC, parity, and/or control information used in mission critical transactions, for example. In one example, the command fields 1312, 1412 may carry a duplicate of the reserved value transmitted in the address field 1314, 1414. A receiver may identify an error condition when there is a difference in value received in the fields 1312/1314, or 1412/1414 of the HDR-Address Command word 1304, 1404. In another example, the command fields 1312, 1412 may carry one or more error detection or correction codes which may be provided as a byte, two nibbles, a combination of 3 bits+3 bits+2 bits, etc. Error detection or correction may be applied to the reserved value in the address field 1314, 1414, the CCC code 1316, the second byte 1318, 1418 of the HDR CCC command word 1306, 1406, or some combination of the address field 1314, 1414, the CCC code 1316, and the second byte 1318, 1418 of the HDR CCC command word 1306. In another example, the second byte 1318, 1418 of the HDR CCC command word 1306 may be used for error detection/correction or for some other purpose when the SDR-CCC code 1316 corresponds to a broadcasted CCC.

### Examples of Apparatus and Methods According to Certain Aspects

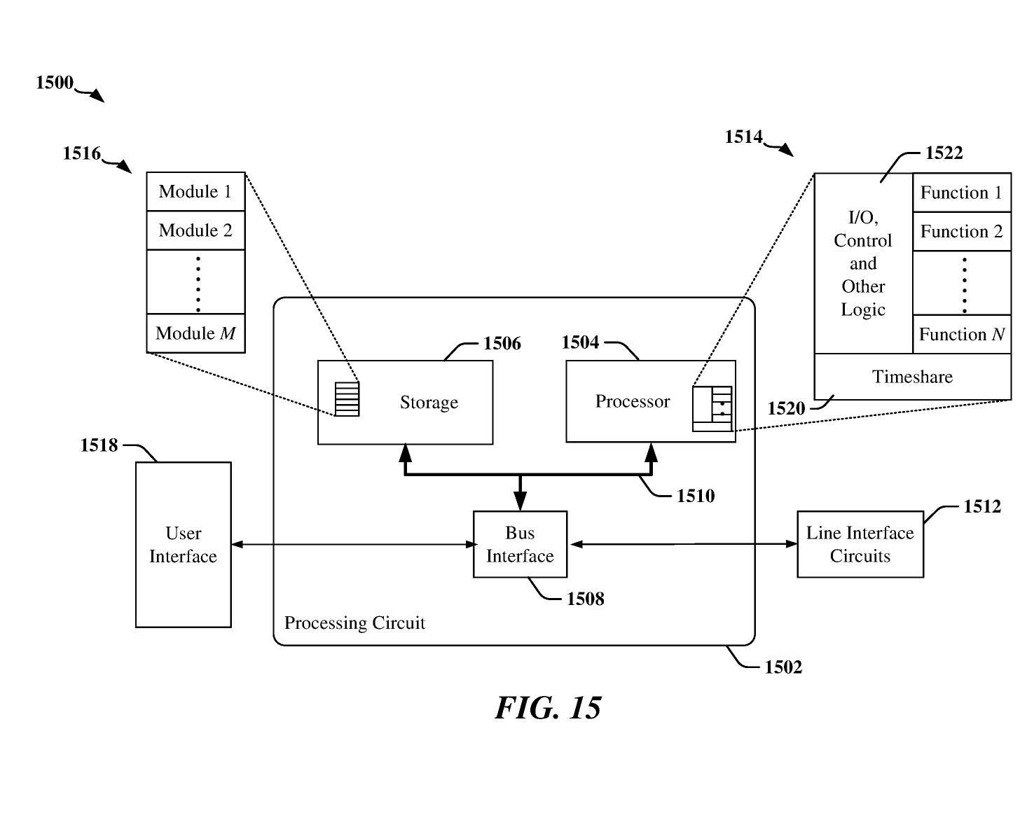

FIG. 15 is a conceptual diagram 1500 illustrating a simplified example of a hardware implementation for an apparatus employing a processing circuit 1502 that may be configured to perform one or more functions disclosed herein. In accordance with various aspects of the disclosure, an element, or any portion of an element, or any combination of elements as disclosed herein may be implemented using the processing circuit 1502. The processing circuit 1502 may include one or more processors 1504 that are controlled by some combination of hardware and software modules. Examples of processors 1504 include microprocessors, microcontrollers, digital signal processors (DSPs), field programmable gate arrays (FPGAs), programmable logic devices (PLDs), application specific integrated circuits (ASICs), state machines, sequencers, gated logic, discrete hardware circuits, and other suitable hardware configured to perform the various functionality described throughout this disclosure. The one or more processors 1504 may include specialized processors that perform specific functions, and that may be configured, augmented or controlled by one of the software modules 1516. The one or more processors 1504 may be configured through a combination of software modules 1516 loaded during initialization, and further configured by loading or unloading one or more software modules 1516 during operation.

In the illustrated example, the processing circuit 1502 may be implemented with a bus architecture, represented generally by the bus 1510. The bus 1510 may include any number of interconnecting buses and bridges depending on the specific application of the processing circuit 1502 and the overall design constraints. The bus 1510 links together various circuits including the one or more processors 1504, and storage 1506. Storage 1506 may include memory devices and mass storage devices, and may be referred to herein as computer-readable media and/or processor-readable media. The bus 1510 may also link various other circuits such as timing sources, timers, peripherals, voltage regulators, and power management circuits. A bus interface 1508 may provide an interface between the bus 1510 and one or more transceivers 1512. A transceiver 1512 may be provided for each networking technology supported by the processing circuit. In some instances, multiple networking technologies may share some or all of the circuitry or processing modules found in a transceiver 1512. Each transceiver 1512 provides a means for communicating with various other apparatus over a transmission medium. Depending upon the nature of the apparatus, a user interface 1518 (e.g., keypad, display, touch interface, speaker, microphone, joystick) may also be provided, and may be communicatively coupled to the bus 1510 directly or through the bus interface 1508.

A processor 1504 may be responsible for managing the bus 1510 and for general processing that may include the execution of software stored in a computer-readable medium that may include the storage 1506. In this respect, the processing circuit 1502, including the processor 1504, may be used to implement any of the methods, functions and techniques disclosed herein. The storage 1506 may be used for storing data that is manipulated by the processor 1504 when executing software, and the software may be configured to implement any one of the methods disclosed herein.

One or more processors 1504 in the processing circuit 1502 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1506 or in an external computer readable medium. The external computer-readable medium and/or storage 1506 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 1506 may also include, by way of example, a carrier wave, a transmission line, and any other suitable medium for transmitting software and/or instructions that may be accessed and read by a computer. Computer-readable medium and/or the storage 1506 may reside in the processing circuit 1502, in the processor 1504, external to the processing circuit 1502, or be distributed across multiple entities including the processing circuit 1502. The computer-readable medium and/or storage 1506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1506 may maintain software maintained and/or organized in loadable code segments, modules, applications, programs, etc., which may be referred to herein as software modules 1516. Each of the software modules 1516 may include instructions and data that, when installed or loaded on the processing circuit 1502 and executed by the one or more processors 1504, contribute to a run-time image 1514 that controls the operation of the one or more processors 1504. When executed, certain instructions may cause the processing circuit 1502 to perform functions in accordance with certain methods, algorithms and processes described herein.

Some of the software modules 1516 may be loaded during initialization of the processing circuit 1502, and these software modules 1516 may configure the processing circuit 1502 to enable performance of the various functions disclosed herein. For example, some software modules 1516 may configure internal devices and/or logic circuits 1522 of the processor 1504, and may manage access to external devices such as the transceiver 1512, the bus interface 1508, the user interface 1518, timers, mathematical coprocessors, and so on. The software modules 1516 may include a control program and/or an operating system that interacts with interrupt handlers and device drivers, and that controls access to various resources provided by the processing circuit 1502. The resources may include memory, processing time, access to the transceiver 1512, the user interface 1518, and so on.

One or more processors 1504 of the processing circuit 1502 may be multifunctional, whereby some of the software modules 1516 are loaded and configured to perform different functions or different instances of the same function. The one or more processors 1504 may additionally be adapted to manage background tasks initiated in response to inputs from the user interface 1518, the transceiver 1512, and device drivers, for example. To support the performance of multiple functions, the one or more processors 1504 may be configured to provide a multitasking environment, whereby each of a plurality of functions is implemented as a set of tasks serviced by the one or more processors 1504 as needed or desired. In one example, the multitasking environment may be implemented using a timesharing program 1520 that passes control of a processor 1504 between different tasks, whereby each task returns control of the one or more processors 1504 to the timesharing program 1520 upon completion of any outstanding operations and/or in response to an input such as an interrupt. When a task has control of the one or more processors 1504, the processing circuit is effectively specialized for the purposes addressed by the function associated with the controlling task. The timesharing program 1520 may include an operating system, a main loop that transfers control on a round-robin basis, a function that allocates control of the one or more processors 1504 in accordance with a prioritization of the functions, and/or an interrupt driven main loop that responds to external events by providing control of the one or more processors 1504 to a handling function.

The processing circuit 1502 may be deployed in various types and examples of electronic devices, including devices that are subcomponents of a mobile apparatus such as a telephone, a mobile computing device, an appliance, automobile electronics, avionics systems, etc. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, a wearable computing device (e.g., a smartwatch, a health or fitness tracker, etc.), an appliance, a sensor, a vending machine, or any other similar functioning device.

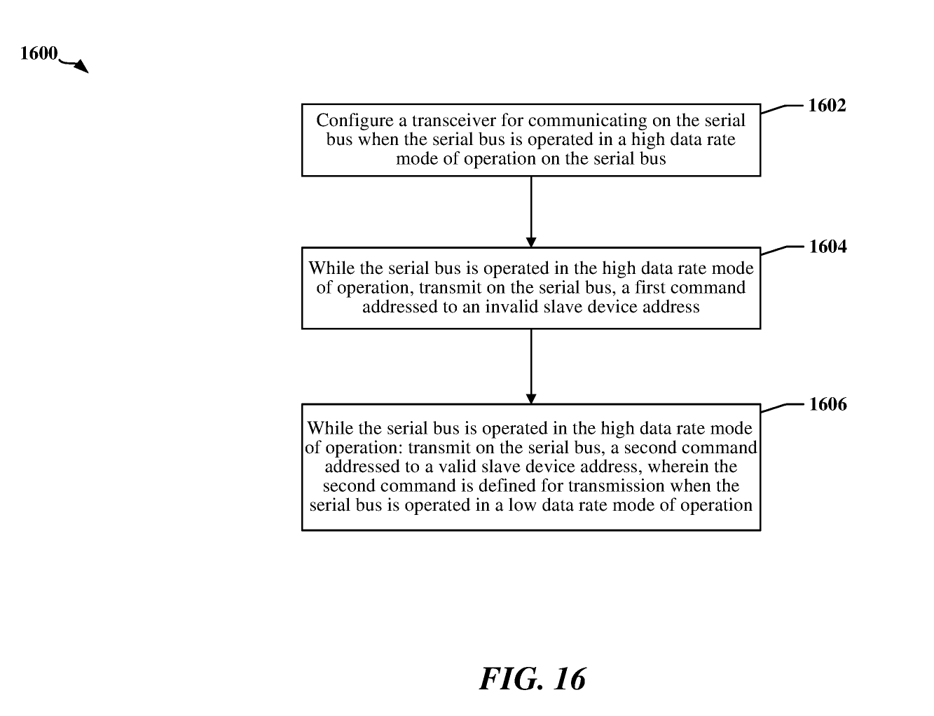

FIG. 16 is a flowchart 1600 illustrating a method for data communications. The method may be performed by a bus master device coupled to a serial bus.

At block 1602, the bus master may configure a transceiver for communicating on the serial bus when the serial bus is operated in a high data rate mode of operation on the serial bus. The high data rate mode of operation may correspond to an I3C HDR-DDR mode of operation, an I3C HDR-TSL mode of operation or an I3C HDR-TSP mode of operation.

At block 1604, the bus master may transmit on the serial bus, a first command addressed to an invalid slave device address while the serial bus is operated in the high data rate mode of operation.

At block 1606, the bus master may be transmitting on the serial bus, a second command addressed to a valid slave device address while the serial bus is operated in the high data rate mode of operation. The second command may be defined for transmission when the serial bus is operated in a low data rate mode of operation.

In some examples, the high data rate mode of operation is compliant with an I3C high data rate mode of operation and the low data rate mode of operation is compliant with an I3C SDR mode of operation. The second command may include a CCC code defined for transmission while the serial bus is operated in the I3C SDR mode of operation.

In some examples, a start sequence may be transmitted on the serial bus while the serial bus is operated in the low data rate mode of operation and prior to transmitting the first command. A mode command may be transmitted while the serial bus is operated in the low data rate mode of operation and prior to transmitting the first command, where the mode command causes the serial bus to transition to the high rate mode of operation.

In some examples, a restart command is transmitted on the serial bus while the serial bus is operated in the high data rate mode of operation and before the first command is transmitted.

In some examples, transmitting the first command includes populating a first field of the first command with a value calculated to reduce consumption of energy by the transceiver during transmission, and populating a second field of the first command with the invalid slave device.

In some examples, transmitting the first command includes populating a first field of the first command with error detection or correction information, and populating a second field of the first command with the invalid slave device.

In some examples, transmitting the second command includes populating a first field of the second command with a CCC code defined for transmission while the serial bus is operated in the I3C SDR mode of operation. When the CCC is a directed CCC, a second field of the second command may be populated with a valid slave device address. When the CCC is a broadcasted CCC, the second field of the second command may be populated with a value calculated to reduce consumption of energy by the transceiver during transmission.

In some examples, transmitting the second command includes populating a first field of the second command with a CCC code defined for transmission while the serial bus is operated in the I3C SDR mode of operation. When the CCC is a directed CCC, a second field of the second command may be populated with a valid slave device address. When the CCC is a broadcasted CCC, the second field of the second command may be populated with error detection or correction information.

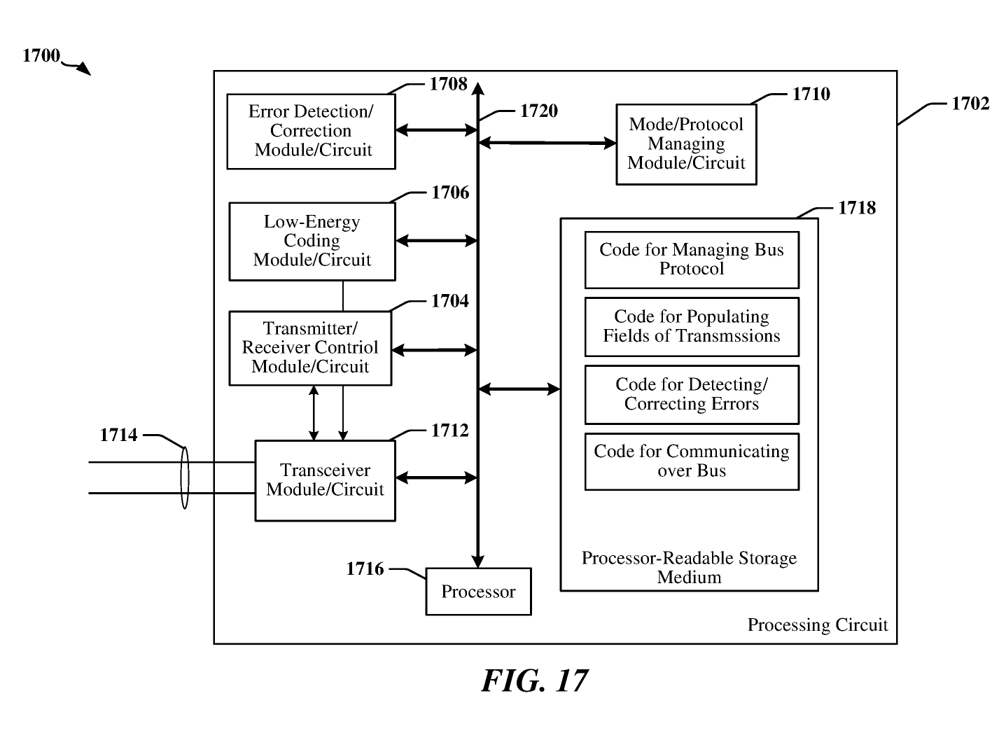

FIG. 17 is a diagram illustrating an example of a hardware implementation for an apparatus 1700 employing a processing circuit 1702. The processing circuit typically has a processor 1716 that may include a microprocessor, microcontroller, digital signal processor, an ASIC, a sequencer or a state machine. The processing circuit 1702 may be implemented with a bus architecture, represented generally by the bus 1720. The bus 1720 may include any number of interconnecting buses and bridges depending on the specific application of the processing circuit 1702 and the overall design constraints. The bus 1720 links together various circuits including one or more processors and/or hardware modules, represented by the processor 1716, the modules or circuits 1704, 1706, 1708, and 1710, a bus interface 1712 operable to couple the apparatus 1700 to a serial bus 1714, and the computer-readable storage medium 1718. The bus 1720 may also link various other circuits such as timing sources, peripherals, voltage regulators, and power management circuits, which are well known in the art.

The processor 1716 is responsible for general processing, including the execution of software stored on the computer-readable storage medium 1718. The software, when executed by the processor 1716, causes the processing circuit 1702 to perform the various functions described supra for any particular apparatus. The computer-readable storage medium 1718 may also be used for storing data that is manipulated by the processor 1716 when executing software, including data communicated through the serial bus 1714. The processing circuit 1702 further includes at least one of the modules 1704, 1706, 1708, and 1710. The modules 1704, 1706, 1708, and 1710 may be software modules running in the processor 1716, resident/stored in the computer-readable storage medium 1718, one or more hardware modules coupled to the processor 1716, or some combination thereof. The modules 1704, 1706, 1708, and/or 1710 may include microcontroller instructions, state machine configuration parameters, or some combination thereof.

In one configuration, the apparatus 1700 may be adapted for use as a bus master coupled to the serial bus 1714. The apparatus 1700 may have a bus interface 1712 which may include interface modules and/or circuits such as a transceiver configured to exchange data through a data line of the serial bus 1714 and a line driver configured to control signaling state of a clock line of the serial bus 1714. The apparatus 1700 may include bus communicating modules and/or circuits 1704, including a transmitter circuit coupled to the transceiver. The apparatus 1700 may include low-energy code word insertion modules and/or circuits 1706 configured to provide values for unused or ignored fields of transmission words. The apparatus 1700 may include error detection and correction modules configured to provide values for unused or ignored fields of transmission words and/or circuits 1708 and protocol and mode of operation management modules and/or circuits 1710.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. As used herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of data communications at a bus master device coupled to a serial bus, comprising:
configuring a transceiver for communicating on the serial bus when the serial bus is operated in a high data rate mode of operation on the serial bus; and
while the serial bus is operated in the high data rate mode of operation:
transmitting on the serial bus, a first command addressed to an invalid slave device address; and
transmitting on the serial bus, a second command addressed to a valid slave device address,
wherein the second command includes a command coded for transmission when the serial bus is operated in a low data rate mode of operation.

2. The method of claim 1, wherein the high data rate mode of operation is compliant with an I3C high data rate mode of operation and the low data rate mode of operation is compliant with an I3C single data rate (SDR) mode of operation.

3. The method of claim 2, wherein the second command comprises a common command code (CCC) defined for transmission while the serial bus is operated in the I3C SDR mode of operation.

4. The method of claim 2, wherein transmitting the second command comprises:
populating a first field of the second command with a common command code (CCC) defined for transmission while the serial bus is operated in the I3C SDR mode of operation;
when the CCC is a directed CCC, populating a second field of the second command with the valid slave device address; and
when the CCC is a broadcasted CCC, populating the second field of the second command with a value calculated to reduce consumption of energy by the transceiver during transmission.

5. The method of claim 2, wherein transmitting the second command comprises:
populating a first field of the second command with a common command code (CCC) defined for transmission while the serial bus is operated in the I3C SDR mode of operation;
when the CCC is a directed CCC, populating a second field of the second command with the valid slave device address; and
when the CCC is a broadcasted CCC, populating the second field of the second command with error detection or correction information.

6. The method of claim 1, further comprising:
transmitting a start sequence or a restart command on the serial bus while the serial bus is operated in the low data rate mode of operation and prior to transmitting the first command; and
transmitting a mode command while the serial bus is operated in the low data rate mode of operation and prior to transmitting the first command, where the mode command causes the serial bus to transition to the high rate mode of operation.

7. The method of claim 1, wherein the high data rate mode of operation corresponds to an I3C high data rate-double data rate (HDR-DDR) mode of operation.

8. The method of claim 1, wherein the high data rate mode of operation corresponds to an I3C high data rate-ternary symbols legacy (HDR-TSL) mode of operation or an I3C high data rate-ternary symbols pure (HDR-TSP) mode of operation.

9. The method of claim 1, wherein transmitting the first command comprises:
populating a first field of the first command with a value calculated to reduce consumption of energy by the transceiver during transmission; and
populating a second field of the first command with the invalid slave device address.

10. The method of claim 1, wherein transmitting the first command comprises:
populating a first field of the first command with error detection or correction information; and
populating a second field of the first command with the invalid slave device address.

11. A bus master configured to be coupled to a serial bus, comprising:
a transceiver configured to exchange data through a data line of the serial bus;
a line driver configured to control signaling state of a clock line of the serial bus; and
a transmitter circuit coupled to the transceiver and the line driver, where while the serial bus is operated in a high data rate mode of operation, the transmitter circuit is configured to:
transmit on the serial bus, a first command addressed to an invalid slave device address; and
transmit on the serial bus, a second command addressed to a valid slave device address,
wherein the second command includes a command coded for transmission when the serial bus is operated in a low data rate mode of operation.

12. The bus master of claim 11, wherein the second command comprises a common command code (CCC) defined for transmission while the serial bus is operated in an I3C single data rate (SDR) mode of operation.

13. The bus master of claim 12, wherein the transmitter circuit is configured to:
populate a first field of the second command with a common command code (CCC) coded for transmission when the serial bus is operated in the I3C SDR mode of operation;
when the CCC is a directed CCC, populate a second field of the second command with the valid slave device address; and
when the CCC is a broadcasted CCC, populate the second field of the second command with a value calculated to reduce consumption of energy by the transceiver during transmission.

14. The bus master of claim 11, wherein the high data rate mode of operation is compliant with an I3C high data rate mode of operation and the low data rate mode of operation is compliant with an I3C single data rate (SDR) mode of operation, and wherein the transmitter circuit is configured to:
populate a first field of the second command with a common command code (CCC) coded for transmission while the serial bus is operated in the I3C SDR mode of operation;
when the CCC is a directed CCC, populate a second field of the second command with the valid slave device address; and
when the CCC is a broadcasted CCC, populate the second field of the second command with error detection or correction information.

15. The bus master of claim 11, wherein the transmitter circuit is configured to:
transmit a start sequence on the serial bus while the serial bus is operated in the low data rate mode of operation and prior to transmitting the first command; and
transmit a mode command while the serial bus is operated in the low data rate mode of operation and prior to transmitting the first command, where the mode command causes the serial bus to transition to the high rate mode of operation.

16. The bus master of claim 11, wherein the transmitter circuit is configured to:
transmit a restart command on the serial bus while the serial bus is operated in the high data rate mode of operation and prior to transmitting the first command.

17. The bus master of claim 11, wherein the high data rate mode of operation corresponds to an I3C high data rate-double data rate (HDR-DDR) mode of operation.

18. The bus master of claim 11, wherein the high data rate mode of operation corresponds to an I3C high data rate-ternary symbols legacy (HDR-TSL) mode of operation or an I3C high data rate-ternary symbols pure (HDR-TSP) mode of operation.

19. The bus master of claim 11, wherein the transmitter circuit is configured to:
populate a first field of the first command with a value calculated to reduce consumption of energy by the transceiver during transmission; and
populate a second field of the first command with the invalid slave device address.

20. The bus master of claim 11, wherein the transmitter circuit is configured to:
populate a first field of the first command with error detection or correction information; and
populate a second field of the first command with the invalid slave device address.

21. An apparatus, comprising:
a serial bus;
a slave device coupled to the serial bus; and
a master device coupled to the serial bus and configured to control communications on the serial bus,
wherein while the serial bus is operated in a high data rate mode of operation on the serial bus the master device is configured to:
transmit on the serial bus, a first command addressed to an invalid slave identifier; and
transmit on the serial bus, a second command addressed to a slave identifier associated with the slave device, wherein the second command includes a command coded for transmission when the serial bus is operated in a low data rate mode of operation.

22. The apparatus of claim 21, wherein the high data rate mode of operation is compliant with an I3C high data rate mode of operation and the low data rate mode of operation is compliant with an I3C single data rate (SDR) mode of operation, and wherein the second command comprises a common command code (CCC) defined for transmission while the serial bus is operated in the I3C SDR mode of operation.

23. The apparatus of claim 21, wherein the master device is configured to:
transmit a start sequence on the serial bus while the serial bus is operated in the low data rate mode of operation and prior to transmitting the first command; and
transmit a mode command while the serial bus is operated in the low data rate mode of operation and prior to transmitting the first command, where the mode command causes the slave device to transition to the high rate mode of operation.

24. The apparatus of claim 21, wherein the master device is configured to:
transmit a restart command on the serial bus while the serial bus is operated in the high data rate mode of operation and prior to transmitting the first command.

25. The apparatus of claim 21, wherein the high data rate mode of operation corresponds to an I3C high data rate-double data rate (HDR-DDR) mode of operation.

26. The apparatus of claim 21, wherein the high data rate mode of operation corresponds to an I3C high data rate-ternary symbols legacy (HDR-TSL) mode of operation or an I3C high data rate-ternary symbols pure (HDR-TSP) mode of operation.

27. The apparatus of claim 21, wherein the master device is configured to:
populate a first field of the first command with a value calculated to reduce consumption of energy by the apparatus during transmission; and
populate a second field of the first command with the invalid slave identifier.

28. The apparatus of claim 21, wherein the master device is configured to:
populate a first field of the first command with error detection or correction information; and
populate a second field of the first command with the invalid slave identifier.

29. A computer-readable storage medium comprising code for:
configuring a transceiver for communicating on a serial bus when the serial bus is operated in a high data rate mode of operation on the serial bus; and
while the serial bus is operated in the high data rate mode of operation:
transmitting on the serial bus, a first command addressed to an invalid slave device address; and
transmitting on the serial bus, a second command addressed to a valid slave device address,
wherein the second command includes a command coded for transmission when the serial bus is operated in a low data rate mode of operation.

30. The computer-readable storage medium of claim 29, wherein transmitting the second command comprises:
populating a first field of the second command with a common command code (CCC) defined for transmission while the serial bus is operated in an I3C SDR mode of operation; and
when the CCC is a directed CCC, populating a second field of the second command with the valid slave device address.
